(19) United States
(12) Patent Application Publication
(10) Pub. No.: US 2026/0231273 A1
(43) Pub. Date: Aug. 6, 2026

(54) USER EQUIPMENT, ACCESS NETWORK NODE, AND METHODS THEREOF FOR IMPLEMENTING AI/ML MODELS

(71) Applicant: NEC Corporation, Tokyo (JP)

(72) Inventors: Xuelong WANG, Guildford (GB); Pravjyot DEOGUN, Milton Keynes (GB); Neeraj GUPTA, London (GB)

(73) Assignee: NEC Corporation, Tokyo (JP)

(21) Appl. No.: 19/154,802

(22) PCT Filed: Feb. 8, 2024
(86) PCT No.: PCT/JP2024/004292

§ 371 Date: Aug. 8, 2025

(30) Foreign Application Priority Data
Feb. 16, 2023 (GB) 2302234.6

(51) Int. Cl. H04W 76/20; H04L 41/16

(52) U.S. Cl. CPC H04W 76/20; H04L 41/16

(57) ABSTRACT

A user equipment, UE, receives, from an access network node, at least one identity of a respective artificial intelligence or machine learning, AI/ML, model, and transmits, to the access network node, a request for a first AI/ML model. The request includes an identity of the respective AI/ML model. The identity of the first AI/ML model is included in the at least one identity of the respective AI/ML model. The UE then receives the first AI/ML model from the access network node.

### TECHNICAL FIELD

The present disclosure relates to a communication system. The present disclosure has particular but not exclusive relevance to wireless communication systems and devices thereof operating according to the 3rd Generation Partnership Project (3GPP) standards or equivalents or derivatives thereof (including LTE-Advanced, Next Generation or 5G networks, future generations, and beyond). The present disclosure has particular, although not necessarily exclusive, relevance to artificial intelligence and machine learning (AI/ML) models used in ‘New Radio’ systems (also referred to as ‘Next Generation’ systems), and similar systems.

### BACKGROUND ART

Recent developments of the 3GPP standards are referred to as the Long-Term Evolution (LTE) of Evolved Packet Core (EPC) network and Evolved UMTS Terrestrial Radio Access Network (E-UTRAN), also commonly referred as ‘4G’. In addition, the term ‘5G’ and ‘new radio’ (NR) refer to an evolving communication technology that is expected to support a variety of applications and services. Various details of 5G networks are described in, for example, Non Patent Literature 1. 3GPP intends to support 5G by way of the so-called 3GPP Next Generation (NextGen) radio access network (RAN) and the 3GPP NextGen core network.

Under the 3GPP standards, a NodeB (or an eNB in LTE, gNB in 5G) is the radio access network (RAN) node (or simply ‘access node’, ‘access network node’ or ‘base station’) via which communication devices (user equipment or ‘UE’) connect to a core network and communicate with other communication devices or remote servers. For simplicity, the present application will use the term RAN node, base station, or access network node to refer to any such access nodes.

Some of the additional developments in 3GPP relate to the use of artificial intelligence (AI) and machine learning (ML), often abbreviated to AI/ML. Predictions or inferences generated using an AI/ML model can be used as part of various methods for improving the reliability or efficiency of communications in the network. For example, AI/ML models can be used to predict the path of a UE based on previous mobility of the UE, used for beam management, or used in methods of encoding and transmitting information. An AI/ML model may be hosted at a base station, and the base station may perform control of communication resources or control related to the status of a UE (e.g. control of UE mobility, or control of a radio resource control, RRC, state of the UE) based on an inference (e.g. determination or prediction) generated using the AI/ML model. The base station may also transmit an inference generated using the model to another node in the network, for use at the other node. Alternatively, an AI/ML model may be hosted at two nodes of the network, for example at a base station and at a UE. In this case, the base station and the UE may both make determinations or predictions using the model. For example, the UE may use the model as part of an encoding process for encoding (and/or compressing) channel state information (CSI) for transmission to the base station, and the base station may use the same model as part of a corresponding decoding (and/or decompression) process for decoding the CSI received from the UE.

### CITATION LIST

### Non Patent Literature

Non Patent Literature 1: NGMN Alliance, “NGMN 5G White Paper V1.0”, February 2015

### SUMMARY OF INVENTION

### Technical Problem

However, improved methods for propagating AI/ML models and associated information between the nodes of the communication network are needed. In some methods, the model used at the UE may need to be the same as the model used at the base station. For example, when inferences generated using the model are being used as part of a communication method between the UE and base station, the UE and the base station may need to use the same version of the model. Improved methods are needed for obtaining and maintaining synchronisation between the model used at the UE and the model used at the base station, for example when the model is updated to a new version at the base station. Moreover, some AI/ML models may be for use by the UE when the UE is in a particular cell (or other location, such as a group of cells), and improved methods are needed for obtaining and using the corresponding AI/ML models at the UE, for example after the UE moves into the cell.

Additionally, improved methods are needed for obtaining or updating an AI/ML model at the UE when the UE transitions between an RRC connected and an RRC idle state, and for determining which AI/ML model should be used at a node of the communication network when a plurality of AI/ML models are stored.

More generally, there is a need for improved methods for enabling more efficient and reliable transmission of information related to AI/ML models between nodes in the communication network.

One of the objects to be accomplished by example embodiments disclosed herein is to provide apparatus and methods that at least partially address the above needs and/or issues.

### Solution to Problem

In one aspect, there is provided a method of a user equipment, UE, the method comprising: receiving a broadcast or multicast transmission from an access network node, wherein the broadcast or multicast transmission includes an indication of an identity of one or more models for generating a determination, prediction or output parameter; determining, based on the indication, to obtain a model of the one or more models; transmitting a request for the model; and receiving the model.

The model may be an artificial intelligence or machine learning, AI/ML, model.

Transmitting the request for the model may comprise transmitting the request to the access network node; and receiving the model may comprise receiving the model from the access network node.

Receiving the model from the access network node may comprise receiving the model in a radio resource control, RRC, message when the UE is in an RRC connected state.

Transmitting the request for the model may comprise transmitting the request to the access network node, a core network node, or a server that stores the model; and receiving the model may comprise receiving the model from the server.

Receiving the model from the server may comprise receiving the model from the server via the access network node, via the core network node, or directly from the server.

The UE may be in an RRC inactive state or an RRC idle state when the UE receives the broadcast or multicast transmission; and the UE may transmit the request as part of a random access procedure.

The random access procedure may comprise: transmitting a random access preamble to the access network node; receiving a random access response from the access network node, the random access response including an indication of a communication resource for use by the UE for transmitting an uplink transmission; and transmitting the uplink transmission to the access network node; wherein the uplink transmission comprises the request for the model.

The uplink transmission may include a cause value that indicates that the uplink transmission includes the request for the model.

Transmitting the request for the model may comprise transmitting the request for the model in an RRC message; and the RRC message may be a dedicated RRC message for requesting the model.

The method may further comprise: receiving, from the access network node, an indication of a time and/or frequency resource for use by the UE for receiving the model when the UE is in an RRC inactive or RRC idle state; and receiving the model, from the access network node, using the indicated time and/or frequency resource when then UE is in the RRC inactive or RRC idle state.

The broadcast or multicast transmission may include an indication of a use case for at least one of the one or more models.

The broadcast or multicast transmission may include at least one of a model identification number or an indication of a model version of the one or more models.

The broadcast or multicast transmission may include the indication of the model version; and the determination to obtain the model may be based on a comparison of the indicated model version and a model version of a model stored at the UE.

Receiving the model may comprise receiving the model using a data radio bearer or logical channel; and the data radio bearer or logical channel may have an associated transmission priority or bit rate.

Receiving the model may comprise receiving the model using a dedicated data radio bearer or dedicated logical channel.

Receiving the model may comprise receiving the model from a core network node using non-access stratum, NAS, signalling.

The indication of the identity of the one or more models may be included in system information transmitted in the broadcast or multicast transmission.

The system information may be on-demand system information, and the method may further comprise: receiving, from the access network node, an indication that the on-demand system information is available for transmission by the access network node; transmitting, to the access network node, a request for the on-demand system information; and receiving the on-demand system information in the broadcast or multicast transmission.

The system information that includes the indication of the identity of the one or more models may be dedicated system information.

The broadcast or multicast transmission may be a group paging transmission.

The group paging transmission may include an indication that a version of the one or more models has been updated.

The group paging transmission may include a cause value that indicates that a model of the one or more models has been updated to a new version.

In another aspect, there is provided a method of an access network node, the method comprising: transmitting, to a user equipment, UE, a broadcast or multicast transmission, wherein the broadcast or multicast transmission includes an indication of an identity of one or more models for generating a determination, prediction or output parameter; and receiving, from the UE, a request for a model of the one or more models.

The model may be an artificial intelligence or machine learning, AI/ML, model.

The method may further comprise transmitting the requested model to the UE.

A data radio bearer or logical channel for transmission of the requested model may have an associated transmission priority or bit rate; and transmitting the requested model may comprise transmitting the model using the data radio bearer or logical channel and based on the transmission priority or bit rate.

The method may comprise receiving the requested model from a central unit of a base station, a server, or a core network node, before transmitting the requested model to the UE.

The method may further comprise transmitting, to the UE, an indication of a network node from which the UE is to obtain the requested model, or an indication network address for use by the UE to obtain the requested model.

The method may comprise transmitting the broadcast or multicast transmission when the UE is in an RRC inactive state or an RRC idle state; and receiving the request may comprise receiving the request as part of a random access procedure.

The random access procedure may comprise: receiving a random access preamble from the UE; transmitting a random access response to the UE, the random access response including an indication of a communication resource for use by the UE for transmitting an uplink transmission; and receiving the uplink transmission from the UE; wherein the uplink transmission comprises the request for the model.

The uplink transmission may include a cause value that indicates that the uplink transmission includes the request for the model; and the method may further comprise determining the identity of the model requested by the UE based on the request.

The method may further comprise: transmitting, to the UE, an indication of a time and/or frequency resource for use by the UE for receiving the model when the UE is in an RRC inactive or RRC idle state; and transmitting the model, to the UE, using the indicated time and/or frequency resource when then UE is in the RRC inactive or RRC idle state.

The method may comprise receiving, from a central unit of a base station, information indicating the identity of the one or more models, before transmitting the broadcast or multicast transmission that includes the indication of the identity of one or more models.

Transmitting the broadcast or multicast transmission may comprise transmitting the broadcast or multicast transmission periodically or based on a timer.

The broadcast or multicast transmission may include an indication of a use case for at least one of the one or more models.

The broadcast or multicast transmission may include at least one of a model identification number or an indication of a model version of the one or more models.

The indication of the identity of the one or more models may be included in system information transmitted in the broadcast or multicast transmission.

The system information may be on-demand system information, and the method may further comprise: transmitting, to the UE, an indication that the on-demand system information is available for transmission by the access network node; receiving, from the UE, a request for the on-demand system information; and transmitting the on-demand system information in the broadcast or multicast transmission.

The system information that includes the indication of the identity of the one or more models may be dedicated system information.

The broadcast or multicast transmission may be a group paging transmission.

The group paging transmission may include an indication that a version of the one or more models has been updated.

The group paging transmission may include a cause value that indicates that a model of the one or more models has been updated to a new version.

In another aspect, there is provided a method of a user equipment, UE, the method comprising: receiving, from an access network node, an indication that a cell provided by the access network node is part of one or more areas that are each associated with a respective set of one or more models for generating a determination, prediction, or output; determining, based on the received indication, to request a model of the one or more models; transmitting a request for the model; and receiving the model.

An area of the one or more areas may comprise a group of cells, a radio access network based notification area, or a registration area.

The indication that the cell is part of the one or more areas may be received in system information that is broadcast in the cell.

The method may further comprise receiving, from the access network node, an indication of an identity of the one or more models.

The method may further comprise receiving, from the access network node, an indication of one or more use cases of the one or more models.

The one or more models may be artificial intelligence or machine learning, AI/ML, models.

Transmitting the request for the model may comprise transmitting the request to the access network node; and receiving the model may comprise receiving the model from the access network node.

Transmitting the request for the model may comprise transmitting the request to the access network node, a core network node, or a server that stores the model; and receiving the model may comprise receiving the model from the server.

Receiving the model from the server may comprise receiving the model from the server via the access network node, via the core network node, or directly from the server.

In another aspect, there is provided a method of a user equipment, UE, the method comprising: receiving, from an access network node, an indication that a cell provided by the access network node is part of one or more areas that are each associated with a respective set of one or more models for generating a determination, prediction, or output parameter; determining, based on the received indication, to obtain an indication of an identity of at least one of the models; and obtaining the indication of the identity of at least one of the models.

Obtaining the indication of the identity at least one of the models may comprise receiving system information that is broadcast in the cell by the access network node.

The method may further comprise determining to receive the system information periodically or based on a timer.

The model may be an artificial intelligence or machine learning, AI/ML, model.

The method may further comprise determining, based on the indication of the identity of at least one of the models, to obtain a model of the one or more models; transmitting a request for the model; and receiving the model.

Transmitting the request for the model may comprise transmitting the request to the access network node; and receiving the model comprises receiving the model from the access network node.

Transmitting the request for the model may comprise transmitting the request to the access network node, a core network node, or to a server that stores the model; and receiving the model may comprise receiving the model from the server.

Receiving the model from the server may comprise receiving the model from the server via the access network node, via the core network node, or directly from the server.

The method may further comprise, after obtaining the indication of the identity of at least one of the models: selecting a model, of the one or more models for use in the cell, that is stored at the UE; and using the model to generate a determination, prediction, or output parameter.

The method may further comprise transmitting, to the access network node, an indication of the selected model.

Transmitting the indication of the selected model may comprise transmitting the indication of the selected model using in a radio resource control, RRC, message.

In another aspect, there is provided a method of an access network node, the method comprising: transmitting an indication that a cell provided by the access network node is part of one or more areas that are each associated with a respective set of one or more models for generating a determination, prediction, or output; and receiving, from a UE that has received the indication, a request for a model of the one or more models.

The model may be an artificial intelligence or machine learning, AI/ML, model.

The method may further comprise transmitting the requested model to the UE.

The method may further comprise transmitting, to the UE, and indication of a network node from which the UE is to obtain the requested model, or an indication network address for use by the UE to obtain the requested model.

Transmitting the indication of the network node or network address may comprise transmitting the indication of the network node or network address in system information that is broadcast in the cell.

In another aspect, there is provided a method of an access network node, the method comprising: transmitting an indication that a cell provided by the access network node is part of one or more areas that are each associated with a respective set of one or more models for generating a determination, prediction, or output; receiving, from a UE that has received the indication, a request for an identity of a model of the one or more models; and transmitting an indication of the identity of one or more models.

Transmitting the indication of the identity of one or more models for use in the cell may comprise transmitting the indication of the identity of one or more models for use in the cell in system information that is broadcast in the cell.

The method may further comprise transmitting the system information periodically or based on a timer.

The model may be an artificial intelligence or machine learning, AI/ML, model.

In another aspect, there is provided a method of a user equipment, UE, the method comprising: transitioning from a radio resource control, RRC, idle or RRC inactive state to an RRC connected state; and transmitting to an access network node, an indication of at least one of: an identity of one or more models stored at the UE, a status of the one or more models stored at the UE, or a version number of the one or more models stored at the UE; wherein the one or more models are for generating a determination, prediction or output parameter.

The one or more models may be artificial intelligence or machine learning, AI/ML, models.

The indication may be transmitted to the access network node using layer 1, L1, signalling, layer 2, L2, signalling, or layer 3, L3, signalling.

Transmitting the indication of the identity of the one or models may comprise transmitting the indication of the identity of the one or models in an RRC message after the UE has entered the RRC connected state.

In another aspect, there is provided a method of an access network node, the method comprising: receiving, from a user equipment, UE, an indication of at least one of: an identity of one or more models stored at the UE, a status of the one or more models stored at the UE, or a version number of the one or more models stored at the UE; and determining, based on the received indication, a model of the one or more models to use at the access network node; wherein the one or more models are for generating a determination, prediction or output parameter.

The method may further comprise transmitting, to the UE, an indication of the determined model.

The one or more models may be artificial intelligence or machine learning, AI/ML, models.

In another aspect, there is provided a method of a user equipment, UE, the method comprising: storing a model for generating a determination, prediction or output parameter; transitioning from a radio resource control, RRC, connected state to an RRC idle or RRC inactive state; and continuing to store the model after the transition from the RRC connected state to the RRC idle or RRC inactive state.

The method may comprise storing the model for a predetermined time duration after the UE has entered the RRC idle or RRC inactive state.

In another aspect, there is provided a method of an access network node, the method comprising, transmitting, to a user equipment, UE, in a first radio resource control, RRC message, a request for an indication of an identity of a model stored at the UE, wherein the model is for generating a determination, prediction or output parameter; and receiving, from the UE, in a second RRC message, the indication of the identity of the model stored at the UE.

In another aspect, there is provided a method of a user equipment, UE, the method comprising, receiving, from an access network node, in a first radio resource control, RRC message, a request for an indication of an identity of a model stored at the UE, wherein the model is for generating a determination, prediction or output parameter; and transmitting, in a second RRC message, to the access network node, the indication of the identity of the model stored at the UE.

In another aspect, there is provided a method of a user equipment, UE, the method comprising, transmitting, to an access network node, in a first radio resource control, RRC message, a request for an indication of a model supported for a use case, wherein the model is for generating a determination, prediction or output parameter for the use case; and receiving, from the access network node, in a second RRC message, an indication of the identity of the model.

In another aspect, there is provided a method of an access network node, the method comprising, receiving, from a user equipment, UE, in a first radio resource control, RRC message, a request for an indication of a model supported for a use case, wherein the model is for generating a determination, prediction or output parameter for the use case; and transmitting, to the UE, in a second RRC message, an indication of the identity of the model.

In another aspect the inventio provides a user equipment, UE, comprising: means for receiving a broadcast or multicast transmission from an access network node, wherein the broadcast or multicast transmission includes an indication of an identity of one or more models for generating a determination, prediction or output parameter; means for determining, based on the indication, to obtain a model of the one or more models; and means for transmitting a request for the model; wherein the means for receiving is configured for receiving the model.

In another aspect, there is provided an access network node comprising: means for transmitting, to a user equipment, UE, a broadcast or multicast transmission, wherein the broadcast or multicast transmission includes an indication of an identity of one or more models for generating a determination, prediction or output parameter; and means for receiving, from the UE, a request for a model of the one or more models.

In another aspect, there is provided a user equipment, UE, comprising: means for receiving, from an access network node, an indication that a cell provided by the access network node is part of one or more areas that are each associated with a respective set of one or more models for generating a determination, prediction, or output; means for determining, based on the received indication, to request a model of the one or more models; and means for transmitting a request for the model; wherein the means for receiving is configured for receiving the model.

In another aspect, there is provided a user equipment, UE, comprising: means for receiving, from an access network node, an indication that a cell provided by the access network node is part of one or more areas that are each associated with a respective set of one or more models for generating a determination, prediction, or output parameter; means for determining, based on the received indication, to obtain an indication of an identity of at least one of the models; and means for obtaining the indication of the identity of at least one of the models.

In another aspect, there is provided an access network node comprising: means for transmitting an indication that a cell provided by the access network node is part of one or more areas that are each associated with a respective set of one or more models for generating a determination, prediction, or output; and means for receiving, from a UE that has received the indication, a request for a model of the one or more models.

In another aspect, there is provided an access network node comprising: means for transmitting an indication that a cell provided by the access network node is part of one or more areas that are each associated with a respective set of one or more models for generating a determination, prediction, or output; and means for receiving, from a UE that has received the indication, a request for an identity of a model of the one or more models; wherein the means for transmitting is configured for transmitting an indication of the identity of one or more models.

In another aspect, there is provided a user equipment, UE, comprising: means for transitioning from a radio resource control, RRC, idle or RRC inactive state to an RRC connected state; and means for transmitting to an access network node, an indication of at least one of: an identity of one or more models stored at the UE, a status of the one or more models stored at the UE, or a version number of the one or more models stored at the UE; wherein the one or more models are for generating a determination, prediction or output parameter.

In another aspect, there is provided an access network node comprising: means for receiving, from a user equipment, UE, an indication of at least one of: an identity of one or more models stored at the UE, a status of the one or more models stored at the UE, or a version number of the one or more models stored at the UE; and means for determining, based on the received indication, a model of the one or more models to use at the access network node; wherein the one or more models are for generating a determination, prediction or output parameter.

In another aspect, there is provided a user equipment, UE, comprising: means for storing a model for generating a determination, prediction or output parameter; and means for transitioning from a radio resource control, RRC, connected state to an RRC idle or RRC inactive state; wherein the UE is configured to continue to store the model after the transition from the RRC connected state to the RRC idle or RRC inactive state.

In another aspect, there is provided an access network node comprising, means for transmitting, to a user equipment, UE, in a first radio resource control, RRC message, a request for an indication of an identity of a model stored at the UE, wherein the model is for generating a determination, prediction or output parameter; and means for receiving, from the UE, in a second RRC message, the indication of the identity of the model stored at the UE.

In another aspect, there is provided a user equipment, UE, comprising, means for receiving, from an access network node, in a first radio resource control, RRC message, a request for an indication of an identity of a model stored at the UE, wherein the model is for generating a determination, prediction or output parameter; and means for transmitting, in a second RRC message, to the access network node, the indication of the identity of the model stored at the UE.

In another aspect, there is provided a user equipment, UE, comprising, means for transmitting, to an access network node, in a first radio resource control, RRC message, a request for an indication of a model supported for a use case, wherein the model is for generating a determination, prediction or output parameter for the use case; and means for receiving, from the access network node, in a second RRC message, an indication of the identity of the model.

In another aspect, there is provided an access network node comprising, means for receiving, from a user equipment, UE, in a first radio resource control, RRC message, a request for an indication of a model supported for a use case, wherein the model is for generating a determination, prediction or output parameter for the use case; and means for transmitting, to the UE, in a second RRC message, an indication of the identity of the model.

### Advantageous Effects of Invention

According to the aspects described above, it is possible to provide apparatuses, methods and programs that contribute to at least partially address one or more of the above needs and/or issues.

### BRIEF DESCRIPTION OF DRAWINGS

Example embodiments will now be described, by way of example, with reference to the accompanying drawings in which:

FIG. 1 schematically illustrates a mobile (‘cellular’ or ‘wireless’) telecommunication system;

FIG. 2 illustrates a typical frame structure that may be used in the telecommunication system of FIG. 1;

FIG. 3 is a schematic block diagram illustrating the main components of a DU 50 that may be used as part of the RAN equipment 5 for the communication system 1 shown in FIG. 1;

FIG. 4 is a schematic block diagram illustrating the main components of a CU 60 that may be used as part of the RAN equipment 5 for the communication system 1 shown in FIG. 1;

FIG. 5 shows a mobility procedure in which handover occurs from a source (R)AN node to a target (R)AN node;

FIG. 6 shows a random access (RA) procedure that may be performed in the system of FIG. 1;

FIG. 7 shows a schematic illustration of point to point and point to multipoint transmissions;

FIG. 8 illustrates a framework in respect of an AI/ML model;

FIG. 9 shows an illustration of a method of training an AI/ML model, and of monitoring the performance of the AI/ML model;

FIG. 10 shows an example of an AI/ML request and an AI/ML response;

FIG. 11 shows an example of an AI/ML information update;

FIG. 12 shows an example of UE mobility information feedback;

FIG. 13 shows a further example of UE mobility information feedback;

FIG. 14 shows an example of a method in which the base station 5 broadcasts an indication of supported AI/ML models;

FIG. 15 shows an example in which an AI/ML model is transmitted to the UE from an AI/ML server via a base station;

FIG. 16 shows an example in which an AI/ML model is transmitted to the UE from a CU of a distributed base station via a DU;

FIG. 17 shows an example in which the network is configured to use paging to notify one or more UEs of an update to an AI/ML model;

FIG. 18 shows an example of AI/ML model function areas;

FIG. 19 illustrates a method in which AI/ML model area information is received by a UE;

FIG. 20 is a schematic block diagram illustrating the main components of a UE for the telecommunication system of FIG. 1;

FIG. 21 is a schematic block diagram illustrating the main components of a base station for the telecommunication system of FIG. 1; and

FIG. 22 is a schematic block diagram illustrating the main components of a core network node or function for the telecommunication system of FIG. 1.

### DESCRIPTION OF EMBODIMENTS

Multiple example embodiments described below may be used individually, or two or more of the example embodiments may be appropriately combined with one another. These example embodiments may have novel features different from each other. Accordingly, these example embodiments may contribute to attaining objects or solving problems different from one another and contribute to obtaining advantages different from one another.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures to, for example, produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

### Overview

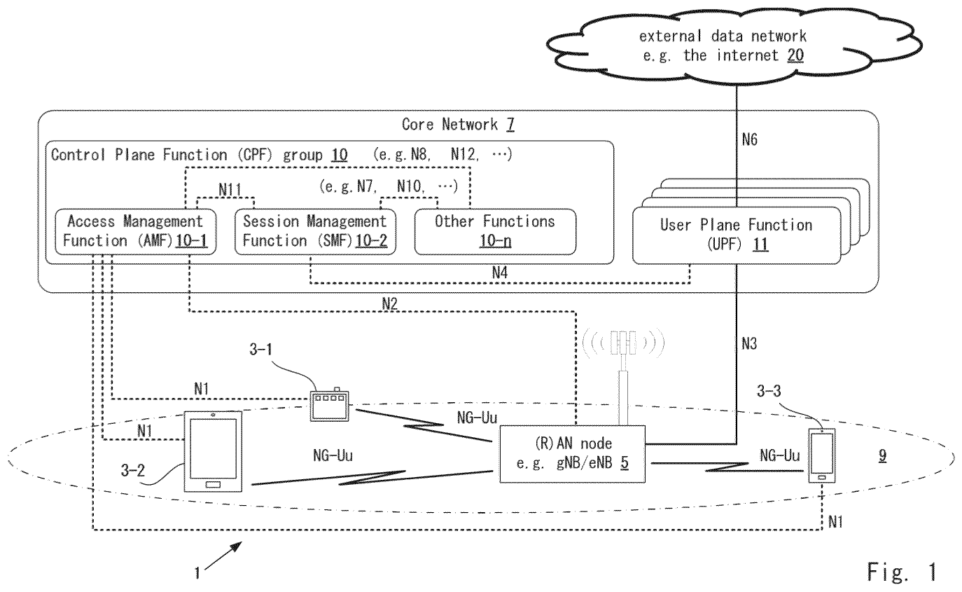

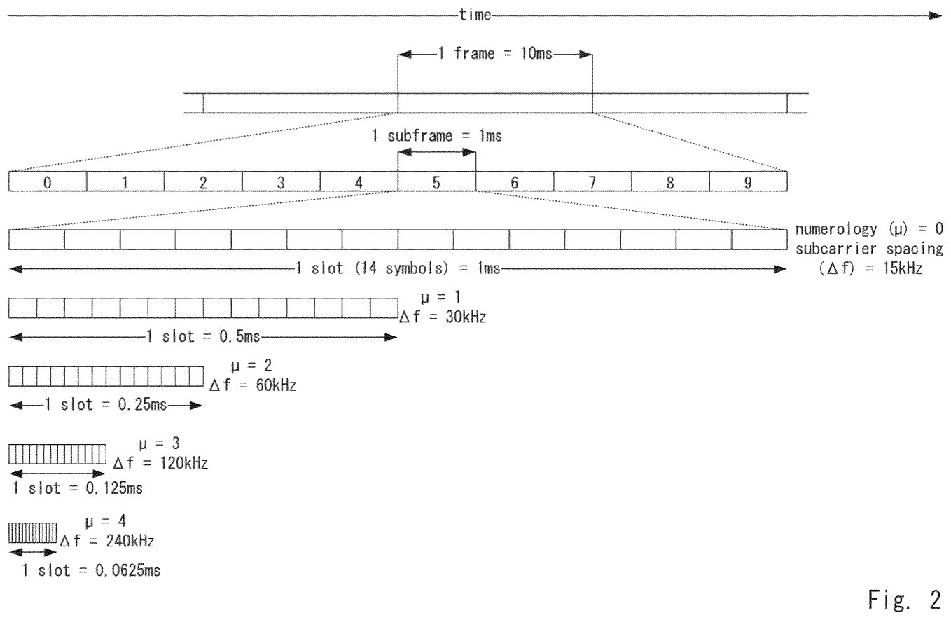

An exemplary telecommunication system will now be described in general terms, by way of example only, with reference to FIGS. 1 and 2.

FIG. 1 schematically illustrates a mobile (‘cellular’ or ‘wireless’) communication system 1 to which example embodiments are applicable.

In the communication system 1 user equipment (UEs) 3-1, 3-2, 3-3 (e.g. mobile telephones and/or other mobile devices) can communicate with each other via a radio access network (RAN) node 5 that operates according to one or more compatible radio access technologies (RATs). In the illustrated example, the RAN node 5 comprises a NR/5G base station or ‘gNB’ 5 operating one or more associated cells 9. Communication via the base station 5 is typically routed through a core network 7 (e.g. a 5G core network or evolved packet core network (EPC)).

As those skilled in the art will appreciate, whilst three UEs 3 and one base station 5 are shown in FIG. 1 for illustration purposes, the system, when implemented, will typically include other base stations 5 and UEs 3.

Each base station 5 controls the one or more associated cells 9 either directly, or indirectly via one or more other nodes (such as home base stations, relays, remote radio heads, distributed units, and/or the like). It will be appreciated that the base stations 5 may be configured to support 4G, 5G, 6G, and/or any other 3GPP or non-3GPP communication protocols.

The UEs 3 and their serving base station 5 are connected via an appropriate air interface (for example the so-called ‘Uu’ interface and/or the like). Neighbouring base stations 5 may be connected to each other via an appropriate base station to base station interface (such as the so-called ‘X2’ interface, ‘Xn’ interface and/or the like).

The core network 7 includes a number of logical nodes (or ‘functions’) for supporting communication in the telecommunication system 1. In this example, the core network 7 comprises control plane functions (CPFs) 10 and one or more user plane functions (UPFs) 11. The CPFs 10 include one or more Access and Mobility Management Functions (AMFs) 10-1, one or more Session Management Functions (SMFs) and a number of other functions 10-n.

The base station 5 is connected to the core network nodes via appropriate interfaces (or ‘reference points’) such as an N2 reference point between the base station 5 and the AMF 10-1 for the communication of control signalling, and an N3 reference point between the base station 5 and each UPF 11 for the communication of user data. The UEs 3 are each connected to the AMF 10-1 via a logical non-access stratum (NAS) connection over an N1 reference point (analogous to the S1 reference point in LTE). It will be appreciated, that N1 communications are routed transparently via the base station 5.

The one or more UPFs 11 are connected to an external data network (e.g. an IP network such as the internet) via reference point N6 for communication of the user data.

The AMF 10-1 performs mobility management related functions, maintains the non-NAS signalling connection with each UE 3 and manages UE registration. The AMF 10-1 is also responsible for managing paging. The SMF 10-2 provides session management functionality (that formed part of MME functionality in LTE) and additionally combines some control plane functions (provided by the serving gateway and packet data network gateway in LTE). The SMF 10-2 also allocates IP addresses to each UE 3.

The base station 5 of the communication system 1 is configured to operate at least one cell 9 on an associated TDD carrier that operates in unpaired spectrum. It will be appreciated that the base station 5 may also operate at least one cell 9 on an associated FDD carrier that operates in paired spectrum.

The base station 5 is also configured for transmission of, and the UEs 3 are configured for the reception of, control information and user data via a number of downlink (DL) physical channels and for transmission of a number of physical signals. The DL physical channels correspond to resource elements (REs) carrying information originated from a higher layer, and the DL physical signals are used in the physical layer and correspond to REs which do not carry information originated from a higher layer.

The physical channels may include, for example, a physical downlink shared channel (PDSCH), a physical broadcast channel (PBCH), and a physical downlink control channel (PDCCH). The PDSCH carries data sharing the PDSCH's capacity on a time and frequency basis. The PDSCH can carry a variety of items of data including, for example, user data, UE-specific higher layer control messages mapped down from higher channels, system information blocks (SIBs), and paging. The PDCCH carries downlink control information (DCI) for supporting a number of functions including, for example, scheduling the downlink transmissions on the PDSCH and also the uplink data transmissions on a physical uplink shared channel (PUSCH). The PBCH provides UEs 3 with the Master Information Block, MIB. It also, in conjunction with the PDCCH, supports the synchronisation of time and frequency, which aids cell acquisition, selection and re-selection. The UE 3 may receive a Synchronization Signal Block (SSB), and the UE 3 may assume that reception occasions of a PBCH, primary synchronization signal (PSS) and secondary synchronization signal (SSS) are in consecutive symbols and form a SS/PBCH block. The base station 5 may transmit a number of synchronization signal (SS) blocks corresponding to different DL beams. The total number of SS blocks may be confined, for example, within a 5 ms duration as an SS burst. The periodicity of the SSB transmissions may be indicated to the UE using any suitable signalling (e.g. per serving cell using ssb-periodicity ServingCell). The periodicity value for the SSB may be, for example, greater than or equal to 20 ms. For initial cell selection, the UE 3 may be configured to assume that an SS burst occurs with a periodicity of 2 frames. The UE 3 may also be provided with an indication of which SSBs within a 5 ms duration are transmitted (e.g. using ssb-Positions InBurst).

The DL physical signals may include, for example, reference signals (RSs) and synchronization signals (SSs). A reference signal (sometimes known as a pilot signal) is a signal with a predefined special waveform known to both the UE 3 and the base station 5. The reference signals may include, for example, cell specific reference signals, UE-specific reference signal (UE-RS), downlink demodulation signals (DMRS), and channel state information reference signal (CSI-RS).

Similarly, the UEs 3 are configured for transmission of, and the base station 5 is configured for the reception of, control information and user data via a number of uplink (UL) physical channels corresponding to REs carrying information originated from a higher layer, and UL physical signals which are used in the physical layer and correspond to REs which do not carry information originated from a higher layer. The physical channels may include, for example, the PUSCH, a physical uplink control channel (PUCCH), and/or a physical random-access channel (PRACH). The UL physical signals may include, for example, demodulation reference signals (DMRS) for a UL control/data signal, and/or sounding reference signals (SRS) used for UL channel measurement.

When the UE 3 initially establishes a radio resource control (RRC) connection with a base station 5 via a cell 9 it registers with an appropriate core network node (e.g. AMF, MME). The UE 3 is in the so-called RRC connected state and an associated UE context is maintained by the network. When the UE 3 is in the so-called RRC idle state, or is in the RRC inactive state, it selects an appropriate cell for camping so that the network is aware of the approximate location of the UE 3 (although not necessarily on a cell level).

The base station 5 may be a base station 5 that is split between one or more distributed units (DUs) 50 and a central unit (CU) 60, with a CU 60 typically performing higher level functions and communication with the next generation core, and with the DU 50 performing lower level functions and communication over an air interface with UEs 3 in the vicinity (i.e. in a cell operated by the base station 5). This type of base station 5 may be referred to as a ‘distributed’ base station 5 or gNB 5. A distributed gNB 5 includes the following functional units:

gNB Central Unit (gNB-CU): a logical node hosting Radio Resource Control (RRC), Service Data Adaptation Protocol (SDAP) and Packet Data Convergence Protocol (PDCP) layers of the gNB (or RRC and PDCP layers of an en-gNB) that controls the operation of one or more gNB-DUs. The gNB-CU terminates the so-called F1 interface connected with the gNB-DU.

gNB Distributed Unit (gNB-DU): a logical node hosting Radio Link Control (RLC), Medium Access Control (MAC) and Physical (PHY) layers of the gNB or en-gNB, and its operation is partly controlled by the gNB-CU. One gNB-DU supports one or multiple cells. One cell is supported by only one gNB-DU. The gNB-DU terminates the F1 interface connected with the gNB-CU.

gNB-CU-Control Plane (gNB-CU-CP): a logical node hosting the RRC and the control plane part of the PDCP protocol of the gNB-CU for an en-gNB or a gNB. The gNB-CU-CP terminates the so-called E1 interface connected with the gNB-CU-UP and the F1-C (F1 control plane) interface connected with the gNB-DU.

gNB-CU-User Plane (gNB-CU-UP): a logical node hosting the user plane part of the PDCP protocol of the gNB-CU for an en-gNB, and the user plane part of the PDCP protocol and the SDAP protocol of the gNB-CU for a gNB. The gNB-CU-UP terminates the E1 interface connected with the gNB-CU-CP and the F1-U (F1 user plane) interface connected with the gNB-DU.

It will be appreciated that when a distributed base station or a similar control plane-user plane (CP-UP) split is employed, the control-plane and user-plane entities may each include an associated transceiver circuit, antenna, network interface, controller, memory, operating system, and communications control module. When the base station 5 comprises a distributed base station, the network interface also includes an E1 interface and an F1 interface (F1-C for the control plane and F1-U for the user plane) to communicate signals between respective functions of the distributed base station.

### Frame Structure

Referring to FIG. 2, which illustrates a typical frame structure that may be used in the communication system 1, the base station 5 and UEs 3 of the telecommunication system 1 communicate with one another using resources that are organised, in the time domain, into frames of length 10 ms. Each frame comprises ten equally sized subframes of 1 ms length. Each subframe is divided into one or more slots comprising 14 Orthogonal frequency-division multiplexing (OFDM) symbols of equal length.

As seen in FIG. 2, the communication system 1 supports multiple different numerologies (subcarrier spacing (SCS), slot lengths and hence OFDM symbol lengths). Specifically, each numerology is identified by a parameter, μ, where μ=0 represents 15 kHz (corresponding to the LTE SCS). Currently, the SCS for other values of μ can, in effect, be derived from μ=0 by scaling up in powers of 2 (i.e. SCS=15×2^{μ} kHz). The relationship between the parameter, μ, and SCS (Δf) is as shown in Table 1:

TABLE 1
5G Numerology

| | | Number of slots | |
|---|---|---|---|
| μ | Δf = 2^{μ} · 15[kHz] | per subframe | Slot length (ms) |
| 0 | 15 | 1 | 1 |
| 1 | 30 | 2 | 0.5 |
| 2 | 60 | 4 | 0.25 |
| 3 | 120 | 8 | 0.125 |
| 4 | 240 | 16 | 0.0625 |

### RAN Equipment

### DU

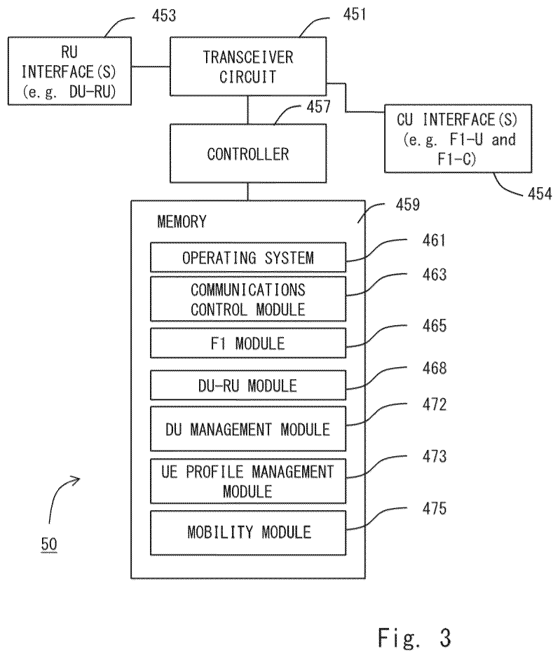

FIG. 3 is a schematic block diagram illustrating the main components of a DU 50 that may be used as part of the RAN equipment 5 for the communication system 1 shown in FIG. 1. As shown, the DU 50 has a transceiver circuit 451 for: transmitting signals to, and for receiving signals from, the communication devices (such as UEs 3) via the radio unit (RU) and the associated DU-RU interface 453; and for transmitting signals to, and for receiving signals from, the CU 60 of the RAN equipment 5 via a CU interface 454 (e.g. comprising an F1 interface which may be split into an F1-U and an F1-C interface for user plane and control plane signalling respectively).

The DU 50 has a controller 457 for controlling the operation of the DU 50. The controller 457 is associated with a memory 459. Software may be pre-installed in the memory 459 and/or may be downloaded via the communication system 1 or from a removable data storage device (RMD) for example. The controller 457 is configured to control the overall operation of the DU 50 by, in this example, program instructions or software instructions stored within memory 459.

As shown, these software instructions include, among other things, an operating system 461, a communications control module 463, an F1 module 465, a DU-RU module 468, a DU management module 472, a UE profile management module 473 and a mobility module 475.

The communications control module 463 is operable to control the communication between the DU 50 and the one or more RUs (and hence between the DU 50 and the UE 3), and between the DU 50 and the CU 60. The communications control module 463 is configured for the overall control of the reception of signals corresponding to uplink communications from the UE 3 and for handling the transmission of downlink communications to the UE 3.

The F1 module 465 is responsible for the appropriate processing of signals received from, or transmitted to, the CU 60 via the one or more CU (e.g. F1) interfaces 454. These signals may be separated into: user plane signals received from, or transmitted to, the CU-UP part of the CU 60 via the F1-U interface; and control plane signals received from, or transmitted to, the CU-CP part of the CU 60 via the F1-C interface.

The DU-RU module 468 is responsible for the appropriate processing of signals received from, or transmitted to, the RU via the one or more RU (e.g. DU-RU) interfaces 453.

The DU management module 472 is responsible for managing the overall operation of the DU 50 and the overall performance of the tasks required of the DU 50. These tasks include, among other things, the generation and transmission of appropriate messages using appropriate signalling application protocols, depending on the functional split between the RU, DU 50 and CU 60, such as interpretation of received MAC signalling and the generation of MAC signalling for transmission. The DU management module 472 may control the overall operation of the DU 50 in accordance with any of the methods describe below, where appropriate.

The UE profile management module 473 is responsible for carrying out functions related to the UE profile including (where applicable): the reception and storage of the UE profile or related assistance/preference information from the UE 3 or from elsewhere in the network; the determination (where applicable) of appropriate mobility specific configurations, based on the UE profile/assistance information/preference information, for implementation at the UE 3 and/or RAN equipment; and/or the provision of configuration information (where applicable) for configuring the UE appropriately with mobility based configurations. The UE profile management module 473 may also store, for example, previous mobility information for a UE 3 (e.g. previous movements of the UE 3 between different communication cells of the network). It will be appreciated that, depending on implementation, the gNB-DU may not implement at least some of these features.

The mobility module 475 is responsible for controlling mobility procedures for one or more UEs 3. For example, the mobility module 475 may be configured to perform one or more measurements for UE 3 mobility, or to select a candidate cell for handover. It will be appreciated that the mobility module 475 may be configured to perform control in any of the mobility methods (e.g. handover) described below.

### CU

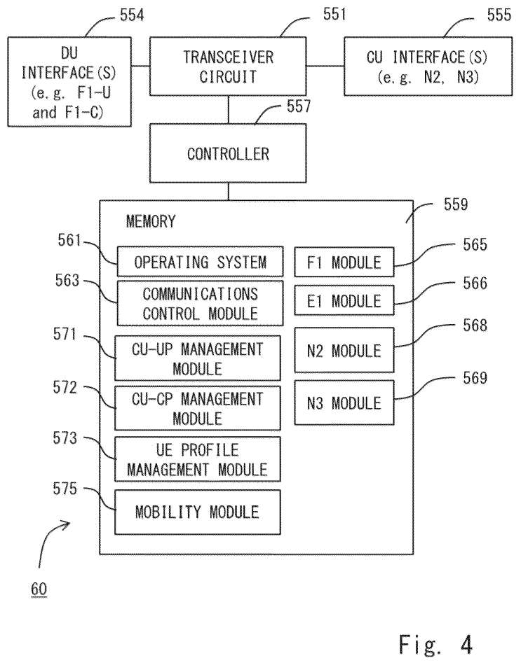

FIG. 4 is a schematic block diagram illustrating the main components of the CU 60 of the RAN equipment for the communication system 1 shown in FIG. 1. As shown, the CU 60 has a transceiver circuit 551 for: transmitting signals to, and for receiving signals from, the DU 50 via the one or more DU interfaces 554 (e.g. comprising an F1 interface which may be split into an F1-U and an F1-C interface for user plane and control plane signalling respectively); and for transmitting signals to, and for receiving signals from, the functions of the core network 7 via one or more core network interfaces 555 (e.g. comprising the N2 and N3 interfaces or the like).

The CU 60 has a controller 557 to control the operation of the CU 60. The controller 557 is associated with a memory 559. Software may be pre-installed in the memory 559 and/or may be downloaded via the communication system 1 or from a removable data storage device (RMD) for example. The controller 557 is configured to control the overall operation of the CU 60 by, in this example, program instructions or software instructions stored within memory 559.

As shown, these software instructions include, among other things, an operating system 561, a communications control module 563, an F1 module 565, an E1 module 566, an N2 module 568, an N3 module 569, a CU-UP management module 571, a CU-CP management module 572, a UE profile management module 573, and a mobility module 575. The functions of the mobility module 575 are the same as described above with reference to FIG. 3.

The communications control module 563 is operable to control the communication between the CU 60 and the one or more DUs 50 (and hence between the CU 60 and the UE 3), and between the CU 60 and the core network 7. The communications control module 563 is configured for the overall control of the reception of signals corresponding to uplink communications from the UE 3 and for controlling the transmission of downlink communications.

The F1 module 565 is responsible for the appropriate processing of signals received from, or transmitted to, the DU 50 via the one or more DU (e.g. F1) interfaces 554. These signals include: user plane signals received at, or transmitted by, the CU-UP part of the CU 60 via the F1-U interface; and control plane signals received at, or transmitted by, the CU-CP part of the CU 60 via the F1-C interface.

The E1 module 566 is responsible for the appropriate processing of signals transmitted between the CU-UP part of the CU 60 and the CU-CP part of the CU 60 via the corresponding internal CU interface (e.g. E1).

The N2 module 568 is responsible for the appropriate processing of signals received from, or transmitted to, the AMF 8-1 via the corresponding one of one or more core network interfaces (e.g. N2) 555.

The N3 module 569 is responsible for the appropriate processing of signals received from, or transmitted to, the one or more core network user plane functions via the corresponding one or more core network interfaces (e.g. N3) 555.

The CU-UP management module 571 is responsible for managing the overall operation of the CU-UP part of the CU 60 and the overall performance of the tasks required of the CU-UP.

The CU-CP management module 572 is responsible for managing the overall operation of the CU-CP part of the CU 60 and the overall performance of the tasks required of the CU-CP. These tasks include, among other things, the generation and transmission of appropriate messages using appropriate signalling application protocols, depending on the functional split between the RU, DU 50 and CU 60, such as interpretation of received RRC signalling and the generation of RRC signalling for transmission.

The UE profile management module 573 is responsible for carrying out functions related to the UE (mobility) profile including (where applicable): the reception and storage of the UE profile or related assistance/preference information from the UE 3 or from elsewhere in the network; the determination of appropriate mobility specific configurations, based on the UE profile/assistance information/preference information, for implementation at the UE 3 and/or RAN equipment 5; and/or the provision of configuration information for configuring the UE appropriately with mobility based configurations. The UE profile management module 573 may also store previous mobility information for a UE 3 (e.g. previous movements of the UE 3 between different communication cells of the network). It will be appreciated that, depending on implementation, the gNB-CU 60 may not implement at least some of these features.

### System Information and SIB

It will be appreciated that transmissions in a cell 9 of a base station 5 may include one or more broadcast transmissions, one or more unicast transmissions for reception by a UE 3, and/or one or more multicast transmissions for reception by a group of UEs 3. System information (SI) transmitted in a cell may include ‘minimum SI’ (MSI) and ‘other SI’ (OSI). The OSI may be broadcast on-demand, for example using a downlink shared channel (DL-SCH). The OSI may be broadcast upon request from a UE 3 that is in a radio resource control (RRC) idle or RRC inactive state. The OSI may also be requested by a UE 3 that is in the RRC connected state, for example via one or more dedicated RRC transmissions.

The SI may include information for enabling (e.g. configuring) the UE 3 to complete a cell selection, may include information for enabling the UE 3 to complete a cell reselection procedure, or for enabling the UE 3 to receive one or more paging messages transmitted in a cell. SI may be broadcast using a Master Information Block (MIB) and one or more System Information Blocks (SIB).

The MSI comprises the MIB and system information block 1 (SIB1). The MIB includes information for use by the UE 3 to receive SIB1, for example a subcarrier spacing for SIB1. The MIB provides information corresponding to a Control Resource Set (CORESET) and Search Space. SIB1 may be referred to as ‘remaining MSI’ (RMSI). SIB1 may be transmitted in a dedicated RRC message, and other SIB (e.g. SIB2 to SIB9) may be transmitting using one or more other suitable RRC transmissions (e.g. another dedicated RRC message). The MIB and SIB1 may provide the UE 3 with an indication of scheduling information for receiving and decoding the other SIB, such as SIB2 to SIB9, and may provide information for use by the UE 3 to receive one or more paging messages. The OSI may comprise, for example, SIB2 to SIB9 transmitted using a DL-SCH in SI messages. A mapping of SIB2 to SIB9 to corresponding SI messages may be provided to the UE 3 by the base station 5. MIB and SIB1 to SIB9 are described in more detail, for example, in 3GPP TS 38.331. SIB2 provides information for intra-frequency, inter-frequency and inter-system cell reselection. SIB3 provides cell-specific information for intra-frequency cell reselection. SIB4 provides information for inter-frequency cell reselection. SIB5 provides information regarding inter-system cell reselection towards 4G (LTE). SIB6 and SIB7 provide information for an earthquake and tsunami warning system (ETWS). SIB8 provides information for a commercial mobile alert service (CMAS) notification, for example to provide warning text messages to the UE 3. SIB9 includes information regarding coordinated universal time (UTC), global positioning system (GPS) time (e.g. for GPS initialisation) and local time.

SIB may be broadcast periodically (e.g. according to a predetermined periodic pattern), or alternatively may be provided ‘on-demand’, for example in response to a request from a UE 3. For example, MIB may be transmitted with a periodicity of 80 ms and repetitions made within 80 ms, and SIB1 may be transmitted with a periodicity of 160 ms and a variable transmission repetition periodicity within 160 ms (e.g. 20 ms). SIB1 can be used to indicate to a UE 3 which SIB are transmitted periodically and which SIB are available on-demand in response to a request from the UE 3. A UE 3 may be configured to request on-demand SIB using message 1 (MSG1), which may be referred to as a MSG1-based on-demand SI request, or message 3 (MSG3), which may be referred to as a MSG3-based on-demand SI request.

A physical broadcast channel (PBCH) can be used to broadcast the MIB. The base station 5 may transmit the PBCH with synchronisation signals (SS) (e.g. primary synchronisation signal (PSS) and secondary synchronisation signal (SSS)) in a SS/PBCH Block. The SS/PBCH block comprises four orthogonal frequency-division multiplexed (OFDM) symbols that are mapped to PSS, SSS and PBCH associated with a demodulation reference signal (DM-RS). In the frequency domain, an SS/PBCH block comprises 240 contiguous subcarriers. When the UE 3 is in an RRC connected state, the base station 5 may provide the UE 3 with an indication of resources used for the SS/PBCH, for example using dedicated signalling. SIB1 may be transmitted using a physical downlink shared channel (PDSCH). The OSI may be similarly transmitted, for example, using a PDSCH. When one or more beamformed transmissions are transmitted in a cell provided by the base station 5, some of the SI (e.g. some of the SIB) may only be transmitted using particular beams, or using a particular transmission/reception point (TRP).

### UE Mobility

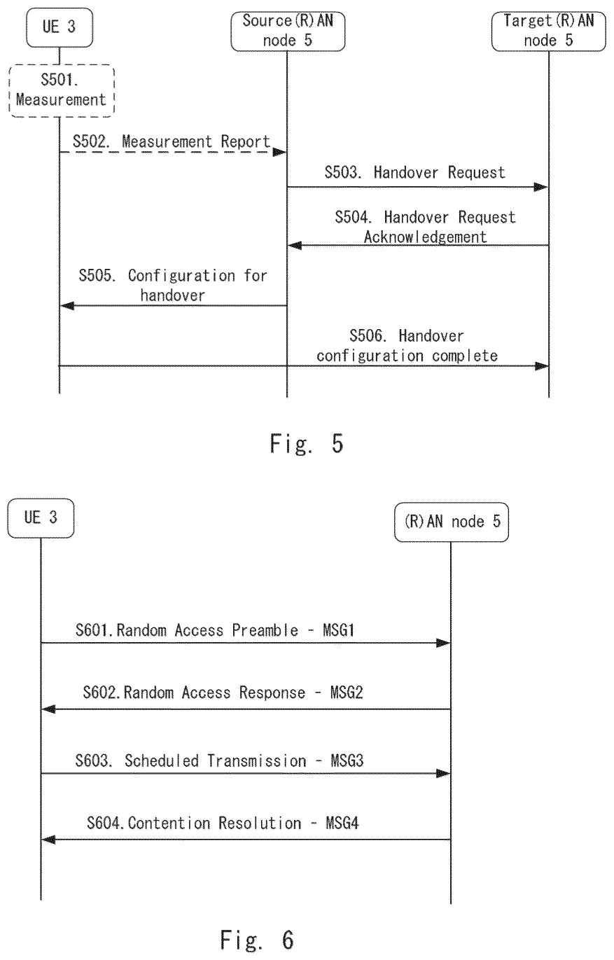

FIG. 5 shows an overview of a mobility procedure that may be performed in a communication system 1 of the type illustrated in FIG. 1. In this example, a handover of a UE 3 from a source base station 5 to a target base station 5 is performed.

In optional step S501 the UE 3 performs a measurement. The measurement may be a measurement of a signal transmitted by the source (R)AN node 5 or a measurement of a signal transmitted by the target (R)AN node 5. The measurement may be a measurement of a signal strength, that can be used as part of a determination that the UE 3 is to be handed over from the source (R)AN node 5 to the target (R)AN node. In optional step S502 the UE 3 transmits a measurement report to the source (R)AN node 5 that provides an indication of the result of the measurement. The measurement report may be transmitted from the UE 3 to the source base station 5 in an RRC message. In this example the source (R)AN node uses the information provided in the measurement report to determine that the UE 3 is to be handed over to the target (R)AN node 5. However, it will be appreciated that a determination that handover to the target (R)AN node is to be performed may alternatively (or additionally) be based on a measurement performed at the source (R)AN node 5 or at the target (R)AN node 5. Alternatively, a determination that handover of the UE 3 is to be performed may be based on a factor other than a signal measurement, such as a level of congestion in a cell operated by the source (R)AN node 5, or an inference (e.g. determination or prediction) generated using an AI/ML model.

In Step S503 the source (R)AN node 5 transmits a handover request to the target (R)AN node 5, requesting handover of the UE 3 from the source (R)AN node 5 to the target (R)AN node 5. The handover request may include an indication of, for example, an identity of the source (R)AN node 5, a cause value for the handover, an identity of the target cell, UE 3 context information (e.g. a maximum bit rate of the UE 3, or security capabilities of the UE 3), and UE history information. If the handover has been triggered by the measurement report received by the source (R)AN node 5 in step S502, then the cause value may indicate, for example, that the handover is desirable for radio reasons. Alternatively, if the handover has been triggered to reduce the load at the source (R)AN node 5, the cause value may indicate that the handover is for reducing load in the serving cell. The handover request message may also include an indication of the AMF 10-1 that is serving the UE 3.

In step S504, the target (R)AN node transmits an acknowledgement of the handover request (which may be referred to as a “handover request acknowledgement” message). The handover request acknowledgement message includes an indication of handover configuration information for the handover that is to be forwarded to the UE 3. The handover request acknowledgement message may also include configuration information that enables the source (R)AN node 5 to begin forwarding user plane data for the UE 3 to the target (R)AN node 5.

The transmissions of steps S503 and S504 may be performed over an Xn interface between the source (R)AN node 5 and the target (R)AN node 5 (and therefore the handover procedure in this example may be referred to as an Xn-based handover procedure). Steps S501 to S504 may be referred to as a ‘handover preparation phase’.

In step S505, the source (R)AN node transmits the handover configuration information to the UE 3. The configuration information for the handover may be, for example, an RRC configuration transmitted in an RRC configuration message or an RRC reconfiguration message. In step S506, the UE 3 applies the received configuration for handover and transmits an indication to the target (R)AN node 5 that configuration for the handover is complete. The message transmitted in step S505 may be, for example, an RRC Reconfiguration Complete message. Steps S505 and S506 may be referred to as a ‘handover execution phase’.

Following the handover execution phase, the UE 3 is operable to transmit uplink transmissions to the target (R)AN node 5 (e.g. uplink data) and receive downlink transmissions from the target (R)AN node 5 (e.g. downlink data).

It will be appreciated that mobility methods and handover procedures for the UE 3 are not restricted to the example illustrated in FIG. 5. For example, the UE 3 may be configured to perform a conditional handover (CHO) in which the UE 3 determines whether handover of the UE 3 to a candidate cell is to be performed based on one or more execution conditions. It will also be appreciated that handover may be performed in which the DU 50 changes but the CU 60 remains the same (inter-DU intra-CU handover), in which both the DU 50 and CU 60 change (inter-DU inter-CU handover), or between two cells operated by the same DU 50.

### Random Access

FIG. 6 shows a random access (RA) procedure that may be performed in the system of FIG. 1. The RA procedure can be used, for example, for initial access by a UE 3 that is in the RRC idle mode, or for a transition from the RRC inactive mode to the RRC connected mode. The RA procedure may also be used during handover of the UE 3 from a source base station to a target base station (e.g. the handover procedure described above with reference to FIG. 5), for initial access to the target base station 5.

In step S601 the UE 3 transmits a random access preamble to the base station 5. In this example the UE 3 selects the random access preamble to transmit from a group of random access preambles that are shared with other UEs 3. The transmission of step S601 may be referred to as message 1 (MSG1), and is transmitted using PRACH.

In step S602 the base station 5 transmits a random access response to the UE 3. The transmission of step S602 may be referred to as message 2 (MSG2). The random access response indicates time and/or frequency resources (e.g. resource blocks and/or symbols) for use by the UE 3 to transmit a subsequent transmission to the base station 5. The random access response may also include further information for use by the UE 3 for communication with the base station 5, such as a timing advance (TA) value.

In step S603 the UE 3 transmits a transmission to the base station 5 using the indicated time and/or frequency resources. The transmission of step S603 may be referred to as message 3 (MSG3). The transmission of step S603 may be a layer 2 (L2) or layer 3 (L3) message. The transmission of step S603 may comprise, for example, an RRC setup request, an RRC resume request, an RRC reestablishment request, or an RRC reconfiguration complete message.

If two UEs 3 selected and transmitted the same random access preamble in step S601, and receive and decode MSG2 transmitted by the base station 5 in step S602, then the two UEs may transmit MSG3 using the same time and/or frequency resources. This situation can be referred to as ‘contention’ or ‘collision’. In order to resolve the contention, in step S604 the base station 5 transmits a content resolution message to the UE 3. The transmission of step S604 may be referred to as message 4 (MSG4). MSG4 indicates to the UE 3 whether the MSG3 transmitted by the UE 3 in step S603 was received and successfully decoded by the base station. MSG3 transmitted in step S603 may not have been received or successfully decoded by the base station 5 if the base station 5 decoded a MSG3 transmitted by another UE 3 that is in contention with the UE 3, or if interference occurred between the MSG3 transmitted by the two UEs 3. If MSG3 transmitted by the UE 3 was not decoded by the base station 5 (which the UE 3 may determine if the UE 3 does not receive MSG4 from the base station 5), then the UE 3 returns to step S601 of the method and transmits another MSG1 to the base station 5 (e.g. after selecting a different random access preamble).

The procedure illustrated in FIG. 6 is an example of a contention based RA procedure in which the UE 3 selects the random access preamble from a group of preambles that could also be used by other UEs 3 (and therefore contention can occur if two of the UEs 3 select the same random access preamble). Alternatively, the base station 5 may transmit a random access preamble assignment to the UE 3 before the UE 3 transmits MSG 1 to the base station 5, in which case the RA procedure is contention free (and the contention resolution in step S604 need not be performed). The random access preamble assignment may be transmitted to the UE 3 using an RRC message or layer 1 (L1) signalling (e.g. using DCI carried by a PDCCH). In the method illustrated in FIG. 5, a random access preamble assignment for communication with the target base station 5 may be transmitted to the UE 3 in step S505.

MSG1 and/or MSG 3 may be used by the UE 3 to request, from the base station 5, any of the on-demand SI described above.

### Broadcasts and Multicasts

A base station 5 may transmit a broadcast intended for reception by any UE 3 in a cell of the base station 5, or may transmit a transmission intended for reception by a particular UE 3 (a point to point, PTP, transmission). The base station 5 may also transmit a transmission intended for reception by a particular group of UEs 3 (a point to multiple, PTM, transmission). A transmission intended for reception by a single UE 3 may be referred to as a unicast transmission, and a transmission intended for reception by a group of UEs 3 may be referred to as a multicast transmission.

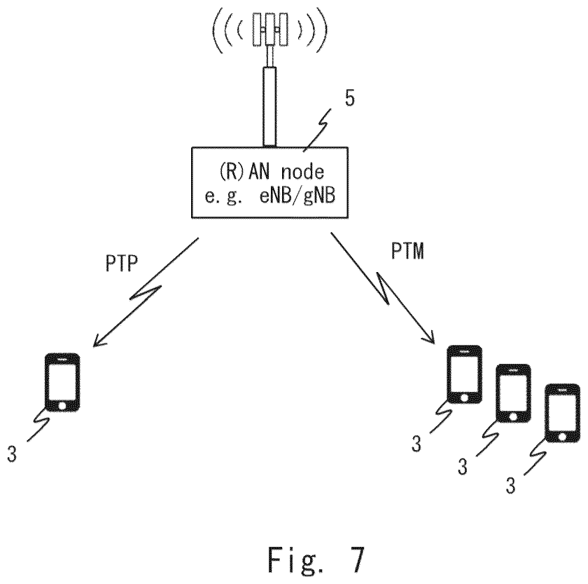

A multicast service may include a PTP leg between a base station 5 and a single UE 3, and a PTM leg between the base station 5 and a plurality of UEs 3. PTP and PTM transmissions are illustrated schematically in FIG. 7. It will be appreciated that whilst the UEs 3 are shown separately in FIG. 7, a UE 3 may receive both the PTP and PTM parts of the multicast. PTP may be described as a PTP ‘leg’ or ‘part’ of a multicast transmission. Similarly, PTM may be described as a PTM ‘leg’ or ‘part’ of a multicast transmission.

The PTM leg has an MBS radio bearer (MRB) that has a corresponding MRB configuration. Each MRB may have an associated identifier (e.g. MRB-Identity) that can be used to identify the MRB. The MRB identity may be included in any suitable transmission for MRB configuration. A multicast service may be suspended (a process in which MRBs are released) or re-activated based on multicast data activity (or inactivity). The configuration of the one or more MRBs may be provided to the UE 3 and/or the base station using any suitable radio link control (RLC) configuration signalling (e.g. in an RLC Bearer Configuration message).

The base station 5 may provide a multicast MRB configuration to the UE 3 via dedicated signalling. The multicast MRB may be configured in a DL only RLC unacknowledge mode (RLC-UM), in which acknowledge/negative-acknowledge (ACK/NACK) feedback is not transmitted, or the MRB may have a bidirectional RLC-UM configuration for PTP transmission.

The multicast MRB configuration may include an RLC-acknowledge mode (RLC-AM) configuration for transmission of ACK/NACK feedback. The multicast MRB configuration may include an RLC-unacknowledge mode (RLC-UM) configuration in which ACK/NACK feedback is not transmitted.

The multicast MRB configuration may include an RLC-AM entity for PTP transmission. The multicast MRB configuration may include a DL only RLC-UM entity for PTM transmission.

The multicast MRB configuration may include two RLC-UM entities. One of the RLC-UM entities may be a DL only RLC-UM entity for PTP transmission, and the other RLC-UM entity may be a DL only RLC-UM entity for PTM transmission.

The multicast MRB configuration may include three RLC-UM entities, wherein one of the RLC-UM entities is a DL only RLC-UM entity, one of the RLC-UM entities is an UL RLC-UM entity for PTP transmissions, and the other RLC-UM entity is a DL only RLC-UM entity for PTM transmission.

The multicast MRB configuration may include two RLC entities, wherein one of the RLC entities is an RLC-AM entity for PTP transmission, and the other RLC entity is a DL only RLC-UM entity for PTM transmission.

### Logical Channels and Logical Channel Priority

A logical channel (LCH) may be a control channel for the transmission of control and/or configuration information (control plane information), or may be a channel used for transmission of user data (user plane information). Logical channels that may be used in the system illustrated in FIG. 1 include the broadcast control channel (BCCH), the paging control channel (PCCH), the common control channel (CCCH) used by the UE 3 during initial access, the dedicated control channel (DCCH) and the dedicated traffic channel (DTCH). One or more transport channels may also be used in the system of FIG. 1. Transport channels include the broadcast channel (BCH), paging channel (PCH), downlink shared channel (DLSCH), uplink shared channel (ULSCH) and random access channel (RACH). Mapping between the logical channels and the transport channels may be performed at the medium access control (MAC) layer, and multiple logical channels may be multiplexed for transmission using a transport channel (e.g. based on the priority of each logical channel, as described later). For example, the BCCH may be mapped to the BCH or the DLSCH, and the PCCH may be mapped to the PCH. The transport channels are mapped to corresponding physical channels (e.g.: PDCCH, PDSCH or PBCH for downlink transmissions; or PUSCH, PUCCH or PUSCH for uplink transmissions).

A logical channel may be identified using a corresponding logical channel ID (LCID). A set of logical channels may be grouped into a logical channel group (LCG), which can be identified using a corresponding index (e.g. an index between 0 and 7).

A logical channel can be assigned a priority by the network (e.g. a transmission priority). For example, a logical channel being used for part of a handover procedure may be assigned a relatively high priority for transmission, since transmission delays in the handover procedure increase the likelihood of handover failure. The base station 5 may determine to preferentially include data (or other information) corresponding to a higher priority logical channel in a medium access control (MAC) protocol data unit (PDU) for transmission to the UE 3, rather than including data or other information corresponding to a lower priority logical channel. The base station 5 may also control the scheduling of uplink transmissions by the UE 3 based on the logical channel priorities.

A prioritised bit rate (PBR) may be defined for a logical channel. The prioritised bit rate may be configured by the base station 5. The prioritised bit rate is a bit rate configured for use for a higher priority logical channel, and the remaining available bit rate (or a portion of the remaining available bit rate) is configured for transmission of the lower priority logical channels. Use of the PBR beneficially helps to avoid a situation in which only the highest priority logical channels are transmitted.

### Artificial Intelligence (AI)/Machine Learning (ML)

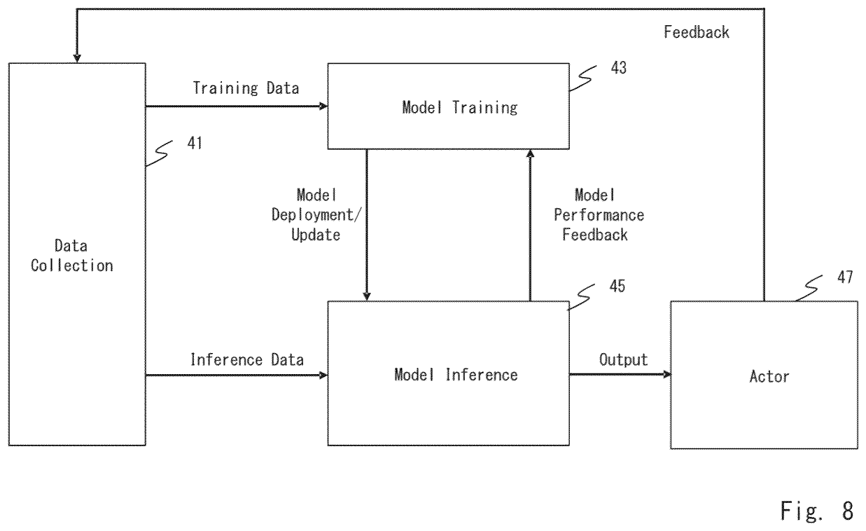

FIG. 8 illustrates a framework in respect of an AI/ML model, and how various entities of the framework may interact with one another.

The entities include a data collection function 41, a model training function 43, a model inference function 45, and an actor 47. The data collection function 41 provides input data (training data) to the model training function 43 and the model inference function 45. The collected data may be, for example, data regarding mobility (e.g. handover of a UE 3, or a location of the UE 3). For example, the data may be obtained by a base station 5 (e.g. by receiving a measurement report from a UE 3, or by receiving data from another base station 5 or a core network node/function) and transmitted to another base station 5 that generates the AI/ML model inference output (or alternatively, the same base station that obtains the data may generate the AI/ML model output). The model training function 43 performs the ML model training, validation, and testing, and may generate model performance metrics as part of a model testing procedure. The model inference function 45 provides AI/ML model inference output (e.g., predictions or decisions), and the actor 47 is a function or node that receives the output from the model inference function 45 and triggers or performs corresponding actions (e.g. a base station 5 that increases/reduces its transmit power, or initiates a handover procedure for a UE 3). The AI/ML model inference output may be, for example, a prediction of mobility (e.g. expected path, route or trajectory, inter-cell or inter-beam mobility, or expected handover) of the UE 3, or one or more parameters for use in encoding or decoding transmissions between the base station 5 and the UE 3. The functions illustrated in FIG. 8 may be co-located at a single node of the communications network (e.g. at a base station 5 or core network node/function), or may be distributed amongst a plurality of network nodes (e.g. a plurality of base stations 5).

Terms referred to by 3GPP in the context of this framework include:
AI/ML Training: An online or offline process for training an AI/ML model.
AI/ML Validation: A method for evaluating the quality (e.g. prediction accuracy) of an AI/ML model using a dataset that is different from the one used for the training of the model.
AI/ML Model Testing: A method for evaluating the performance of a final AI/ML model, using a dataset different from the ones used for training and validation.
AI/ML Data Collection: A method of collecting data by network nodes, a management entity, and/or a UE 3, for training the AI/ML model, for data analytics (e.g. model performance monitoring), and/or for generating an inference using the AI/ML model.
Model Monitoring: A method of monitoring the inference performance (e.g. prediction accuracy) of the AI/ML model.
Training Data: Data for input to the AI/ML Model Training function.
Supervised Learning: A method of training an AI/ML model using labelled data.
Unsupervised Leaning: A method of training an AI/ML model using unlabelled data.
Semi-supervised Learning: A method of training an AI/ML model using both labelled and unlabelled data.
Inference Data: Data for input to the AI/ML Model Inference function, for generating an inference.
Model Deployment/Update: A method of deploying (e.g. transmitting to a network node) an AI/ML model to the Model Inference function, or of delivering an updated model to the Model Inference function.

The data collection 41 may be performed at various nodes of the communication network (e.g. at one or more base stations 5 or UEs 3).

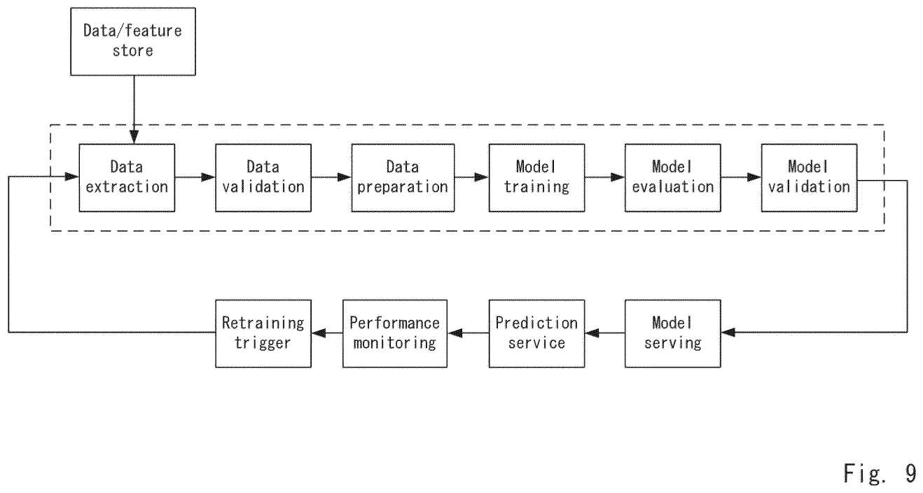

FIG. 9 shows an illustration of a method of training an AI/ML model, and of monitoring the performance of the AI/ML model. As illustrated in FIG. 9, stored data/features may first be extracted in a data extraction step. In the data validation step, a determination of whether to proceed with training or retaining the AI/ML model is made (e.g. based on the extracted data). In the data preparation stage, the data is prepared for use in training the AI/ML model. For example, the data may be cleaned (e.g. filtered), subject to a transformation, or modified in any other suitable manner. The data may also be divided in training data, validation data and test data sets in the data preparation stage.

In the model training step, the AI/ML model is trained (or retrained) using training data prepared in the data preparation step. It will be appreciated that any suitable training method can be used to train the AI/ML model (e.g. a method that comprises supervised learning or unsupervised learning). In the model evaluation step, the AI/ML model is evaluated (e.g. a prediction accuracy of the AI/ML model is evaluated) using a test data set (which may be generated in the data preparation step). In the model validation step, a determination of whether the AI/ML model is suitable for deployment in the communication network is made (e.g. based on the results of the model evaluation step).

In the model serving step, the AI/ML model is deployed for use in the communication network 1. AI/ML model deployment may comprise compiling a trained AI/ML model, packaging the model into an executable format, and delivering the AI/ML model to a target device. For example, the AI/ML model may be transmitted to the base station 5 and/or the UE 3, for use at the base station and/or the UE to generate predictions or determinations using the AI/ML model as part of a prediction service step, as illustrated in the figure. In the performance monitoring step, the performance of the deployed AI/ML model is monitored. The predictive performance of the AI/ML model may be monitored by comparing predictions generated using the model with one or more measurements. For example, when the AI/ML model is used to predict a location of a UE 3, the prediction accuracy of the AI/ML model may be assessed using a measurement of an actual location of the UE 3. Alternatively, if the AI/ML model is used for determining parameters for use in encoding and decoding data transmitted between a base station 5 and a UE 3, the model may be assessed based on the performance of the encoding and/or decoding processes. In the retraining trigger step, retraining of the AI/ML model is triggered (e.g. because the prediction accuracy of the AI/ML model has fallen below an acceptable threshold accuracy, or because a performance of a method that uses inferences from the AI/ML model has fallen below an acceptable threshold performance), and the method returns to the data extraction step.

As described above with reference to FIG. 8, each step of the method of FIG. 9 may be executed at a single node of the communication network 1, or alternatively steps of the method may be distributed between a plurality of different nodes.

### AI/ML for UE Mobility

Examples in which an AI/ML model is used for predicting mobility (e.g. a predicted route/path, inter-cell or inter-beam mobility, or handover) of a UE 3 will now be described. Prediction of the mobility or location of a UE 3 enables more efficient operation of the communication network. For example, radio resource management (such as selection of target handover cells) can be performed more efficiently using a predicted mobility of the UE 3. The predicted mobility of the UE 3 can also be used for early data forwarding (for example, for use in a CHO procedure, such as one of the CHO procedures described above). However, as described above, AI/ML models are not restricted to use for mobility predictions. Alternatively, for example, an AI/ML model may be used to determine parameters for encoding and/or decoding of data transmitted between a UE 3 and a base station 5.

As discussed above with reference to FIGS. 8 and 9, information collected by nodes/functions in the communication network can be used as training data for an AI/ML model, and used as inference data for use in generating one or more model inferences using the AI/ML model. The information used as training data and/or to generating the one or more model inferences may be referred to as ‘AI/ML information’. Methods of requesting and transmitting AI/ML information will now be described.

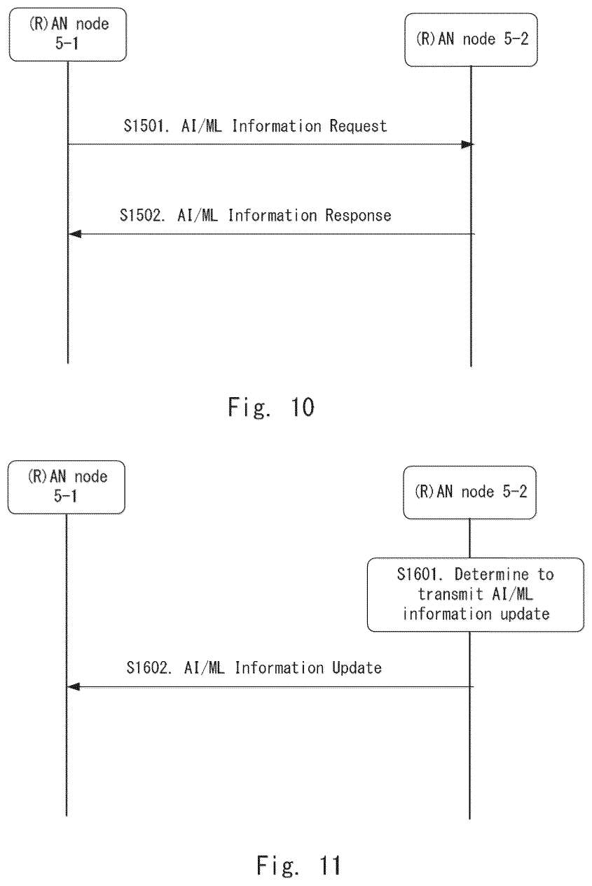

FIG. 10 shows an example of an AI/ML information request and an AI/ML response. In Step S1501, the first base station 5-1 transmits an AI/ML information request to the second base station 5-2. The AI/ML request is a request for AI/ML information (e.g. information regarding an actual mobility of a UE 3) from the second base station 5-2.

After receiving the AI/ML information request in step S1501, the second base station 5-2 transmits an AI/ML Information Response to the first base station 5-1 that includes the AI/ML information. The second base station 5-2 may also begin periodic reporting of the AI/ML information to the first base station 5-1 in response to receiving the AI/ML information request. The periodic reporting may be configured using a corresponding AI/ML information reporting configuration indicated by the AI/ML information request (e.g. including a periodicity of the reporting, number of reports, or reporting duration/time period). The AI/ML information request may include an information element (IE) that indicates that the second base station 5-2 is to start or stop periodic reporting of the AI/ML information to the first base station 5-1. The AI/ML information request may alternatively be a request for a single report of AI/ML information from the second base station 5-2, rather than for periodic reporting.

If the second base station 5-2 is unable to transmit the requested AI/ML information to the first base station 5-1 (e.g. because the requested information is not available at the second base station 5-2), then the base station 5-2 may transmit a corresponding indication to the first base station 5-1 that the second base station is unable to provide the requested information, for example an AI/ML information failure message. The AI/ML information failure message may include an indication of why the second base station 5-2 is unable to provide the requested AI/ML information (e.g. a cause value).

Upon receipt of the AI/ML information, the first base station 5-1 may use the AI/ML information to train (or update) a corresponding AI/ML model (e.g. for UE 3 mobility), or to generate a prediction (e.g. a prediction of UE 3 mobility). Alternatively, the first base station 5-1 may forward the AI/ML information to another network node, for use with an AI/ML model at that network node.

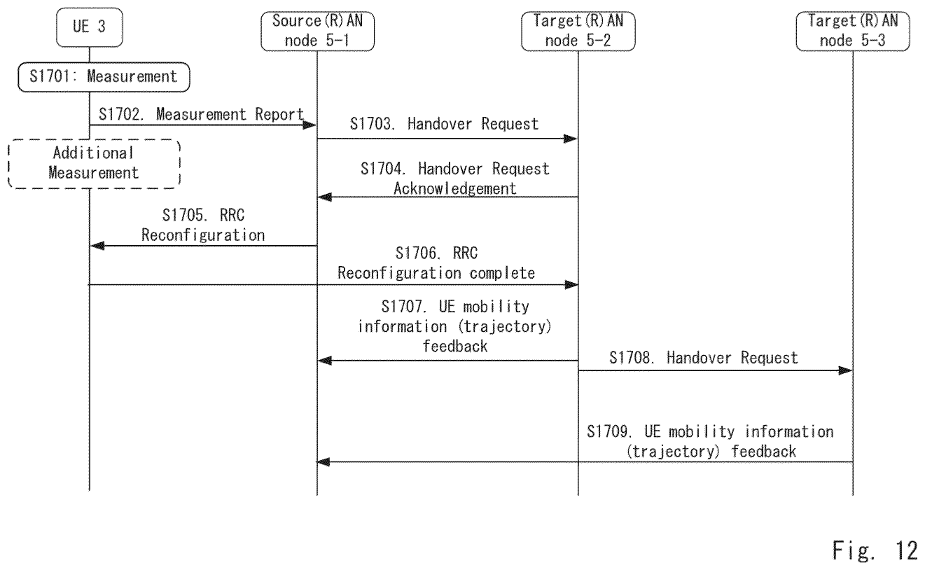

Whilst in the example shown in FIG. 10 the AI/ML information response may include the requested AI/ML information, alternatively the AI/ML information response may be an indication that the second base station 5-2 will transmit the AI/ML information in a subsequent AI/ML information update (e.g. an acknowledgement of the AI/ML information request). FIG. 11 shows an example of an AI/ML information update. In step S1601 the second base station 5-2 determines to transmit an AI/ML information update to the first base station 5. For example, the second base station 5-2 may determine to transmit the AI/ML information update to the first base station 5-2 based on a reporting periodicity received by the second base station 5-2 in step S1501 of FIG. 10, or may determine to transmit the AI/ML information update based on a change in AI/ML information stored at the second base station 5 (or based on new AI/ML information obtained at the second base station 5-2). In step S1602 the second base station 5-2 transmits the AI/ML information to the first base station 5-1 in the AI/ML information update.

### Predicted UE Mobility

Exemplary methods of transmitting a predicted mobility of a UE 3 to nodes/functions in the communication network will now be described. Whilst these examples are described with reference to UE mobility information and corresponding mobility feedback, it will be appreciated that the methods are not limited to being used for mobility predictions and mobility feedback. For example, instead of a mobility prediction, the AI/ML model may be used to generate one or more parameters for encoding and/or decoding of transmissions between the base station 5 and the UE 3. In this case, the feedback may correspond to an indication of the performance of the encoding and/or decoding.

The predicted mobility of the UE 3 may be generated using an AI/ML model, for example using the AI/ML information received in step S1602 of FIG. 11. The predicted mobility of the UE 3 (which may also be referred to as predicted mobility information, or AI/ML model output information) may include a predicted route, path, trajectory, or direction of travel, of the UE 3, or may be an indication of a predicted inter-cell or inter-beam mobility of the UE 3, for example.

### Inter-Base Station Scenario

In an inter-base station 5 handover scenario, the predicted mobility of the UE 3 can be included in a handover request message (e.g. in Step S503 of FIG. 5), enabling the target base station 5 to make use of the predicted UE 3 mobility information (e.g. for more efficient configuration of resources at the target base station 5).

The handover request message transmitted in step S503 may include predicted UE mobility information (e.g. predicted UE trajectory). As described above, the predicted UE mobility information may indicate a predicted route, path or future location of the UE 3, or a predicted inter-cell or inter-beam mobility of the UE 3.

The handover request message may include a predicted UE mobility accuracy, that indicates an accuracy of the prediction. The predicted UE mobility accuracy may be, for example, expressed as a percentage (e.g. as a percentage probability that the prediction is correct or accurate), or in any other suitable format (e.g. as a number of standard deviations). The prediction accuracy may indicate the accuracy of the prediction of the route, path, or location of the UE 3, and/or may indicate the accuracy of a prediction of a duration that the UE 3 will remain in a particular location (e.g. in a particular cell).

The handover request message may include UE history information. For example, the UE history information may include location history information for the UE 3 at the cell level, beam level, tracking area (TA) level, or RAN based notification area (RNA) level. The handover request message may include an indication of the identity of the AI/ML model used to generate the predicted UE 3 mobility. The handover request message may also include an indication of the inputs into the AI/ML model that were used to generate the predicted UE 3 mobility. For example, the handover request message may include an indication of the UE mobility type (e.g. high speed, low speed, medium speed), UE type (e.g. internet of things (IoT) UE, wearable UE, Redcap UE, stationary UE), and/or UE location information or UE fingerprint (e.g. radio frequency fingerprint) input into the AI/ML model.

Whilst the present example of UE mobility information and prediction accuracy information has been described with reference to a handover request message, this need not necessarily be the case. Alternatively, the UE mobility information and/or prediction accuracy information could be included in any other suitable type of transmission to the target base station (e.g. via the UE 3 and the handover configuration complete message of step S505). The received information can be used, for example, to train or retrain an AI/ML model at the target base station 5, beneficially enabling a more accurate prediction of future mobility of the UE 3 to be determined using the AI/ML model at the target base station 5.

### Inter-DU Scenario

During an inter-DU handover, the CU 60 may transmit a UE context setup/modification request message to the target DU 50. The UE context setup/modification request message can be used at the target base station 5 to set up signalling radio bearers (SRBs) and data radio bearers (DRBs) for communication between the target base station 5 and the UE 3. The UE context setup/modification request message may include UE history information at the cell level, beam level, TA level, or RNA level, enabling the target base station 5 to more efficiency configure resources (e.g. time or frequency radio resources) during the handover procedure.

The UE context setup/modification request message may include the predicted mobility information of the UE 3, as described above for the inter-base station scenario. Similarly, the UE context setup/modification request message may include the AI/ML model identity, prediction accuracy, and/or AI model inputs, as described above for the inter-base station scenario.

### NG Handover Scenario

An exemplary next generation (NG) handover (NGHO) scenario will now be described. During NGHO, the predicted UE mobility may be transmitted to the target base-station via the AMF. In a first example, the predicted UE mobility (or other inference—as described above the present examples are not limited to mobility predictions) is transferred via the source base station to the target base station in a transparent container (e.g. using a source NG-RAN Node to Target NG-RAN Node Transparent Container IE in a next generation application protocol (NGAP) ‘handover required’ message). Alternatively, the predicted UE mobility information may be transmitted in an NGAP handover request message, using an appropriate AI/ML prediction information element. The information transmitted to the target base station via the AMF may include the predicted mobility information of the UE 3, as described above for the inter-base station scenario. Similarly, the information transmitted to the target base station via the AMF may include the AI/ML model identity, prediction accuracy, and/or AI model inputs, as described above for the inter-base station scenario.

As illustrated in FIGS. 8 and 9, feedback may be used to improve the AI/ML model (e.g. by training the AI/ML using the feedback), or to verify the accuracy of the AI/ML model. For example, the feedback may be used to determine that the AI/ML model is to be retrained. In this example, feedback may be returned to the source base station via the AMF. The feedback information may be transferred using an NGAP procedure, such as a RAN AI/ML information transfer procedure. The source base station 5 is therefore able to improve the accuracy of the AI/ML model, or verify that the AI/ML model is operating as intended (e.g. within an acceptable accuracy range). The feedback that is transmitted to the source base station may include, for example, information indicating the actual location/mobility of the UE, or any other suitable information. Similarly, in the inter-base station and inter-DU examples described above, the feedback may be transmitted from the target base station/DU to the source base station/DU (e.g. directly or via an intermediate network node) using any suitable message or transmission.

### Beam-Level Prediction/Feedback Information

As described above, the UE mobility prediction may include a prediction of the mobility of the UE 3 at the cell level. Alternatively, the mobility prediction can be made at the beam level. Mobility prediction at the beam level enables more efficient configuration of resources to be performed at the target base station, due to the increase in precision of the prediction. Similarly, the feedback that is returned to the node that operates the AI/ML model may be feedback at the beam level, rather than merely at the cell level, enabling the accuracy of the AI/ML model to be determined at the beam level rather than at the cell level. For both the mobility prediction information and the mobility feedback information, the information may be provided at the beam level instead of at the cell level, or alternatively in addition to the information at the cell level. The level of granularity (e.g. cell-level, beam-level) may be configurable by the network.

### UE Mobility Feedback

Following the handover from the source base station to the target base station, mobility feedback information (e.g. actual UE 3 location or mobility, which could be, for example, on a cell level or beam level) for an AI/ML model can be transmitted to the source base station 5 (e.g. from the target base station, or another base station). As described above, the feedback can be used at the source base station 5 to verify the accuracy of the AI/ML model, to trigger retraining of the AI/ML model, or used to generate a further prediction (or other type of inference) using the AI/ML model. Since handover of the UE 3 from the source base station 5 has occurred, the feedback information may not be available directly at the source base station 5, but can be transmitted to the source base station by another node of the communication network (e.g. by another base station, such as the target base station or a further base station, or by a core network node/function).

When the AI/ML architecture is centralised at a particular base station 5, the base station 5 at which the AI/ML model inferences are generated (and at which the AI/ML is retrained, when needed) may be referred to as the primary base station 5 (or primary RAN node 5). However, this need not necessarily be the case, and alternatively the AI/ML architecture may be provided at another node/function in the communication network, such as a core network node/function. The primary base station 5 (or other network node that hosts the AI/ML model) may request AI/ML information from other nodes in the communication network (e.g. another base station 5) using the procedure described above with reference to FIGS. 10 and 11. Alternatively, or additionally, other nodes in the network may determine to transmit the AI/ML information to the primary base station even without having received an AI/ML information request from the primary base station 5. For example, a target base station 5 may determine to transmit AI/ML mobility information to the primary base station 5 in response to handover of the UE 3 to the target base station (e.g. after a predetermined time following the handover, or in response to a further handover of the UE 3 from the target base station).

The selection of the primary base station 5 (or another network node) may be configurable by the network. The primary base station 5 may be selected for a particular UE 3, for example based on one or more characteristics of the UE 3 (e.g. mobility characteristics). By way of example, a UE 3 may typically move between a home of the user and an office of the user on a particular weekday. The home or office falls within the coverage area of a particular base station 5, which may be selected to serve as the primary base station for the AI/ML model for the UE 3, since this base station is the most likely to have the greatest amount of information regarding the mobility characteristics of the UE 3. When the UE 3 is handed over from the primary base station 5 to a target base station 5 in a handover procedure (e.g. to a base station that provides an area of coverage in which there is a shopping centre that the user visits at the weekend), the target base station may receive a mobility prediction generated using the AI/ML mobility model from the primary base station 5 during the handover procedure (e.g. in step S503 of FIG. 5). The target base station 5 may also feed back information to the primary base station 5 regarding the actual mobility (e.g. trajectory) of the UE 3, so that the primary base station 5 has improved knowledge of the mobility of the UE 3 (which can then be used, for example, at the primary base station 5 to verify the accuracy of the AI/ML model predictions, as described above).

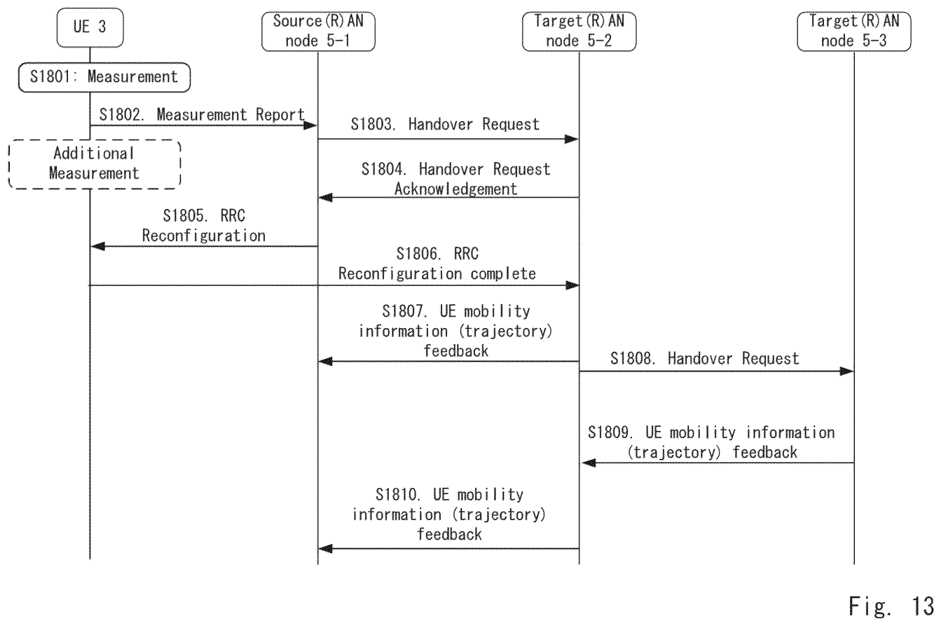

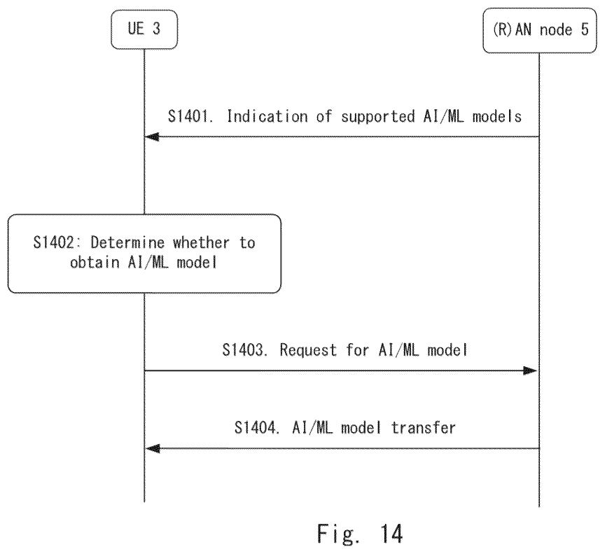

FIGS. 12 and 13 show examples in which UE mobility information is fed back to the source base station 5-1 following a handover of the UE 3 to a first target base station 5-2, and a subsequent handover to a second target base station 5-3. It will be appreciated that the examples of FIG. 12 and FIG. 13 are not limited to mobility predictions and mobility feedback. For example, the AI/ML model hosted at the source base station 5-1 may be configured for generating one or more parameters for encoding and/or decoding of data transmitted between a base station (e.g. the source base station 5-1, first target base station 5-2, or second target base station 5-3) and the UE 3, and the feedback transmitted in step S1709 could include an indication of the performance of the encoding/decoding process, or any other suitable feedback.

In this example, the source base station 5-1 is the primary base station and hosts an AI/ML model for predicting the mobility of the UE 3. Advantageously, information obtained at the second target base station 5-3 regarding the mobility of the UE 3 can be fed back to the source base station 5-1 even when the source base station 5-1 does not have a direct communication link with the second target base station 5-3.

Steps S1701 and S1702 are the same as steps S501 and S502 of FIG. 5 and so will not be described again here. It is noted that the measurement performed by the UE 3 may be generated in a time to trigger (TTT) manner, and that UE 3 may perform one or more additional measurements (shown in the dashed box in FIGS. 12 and 13), which may be transmitted to the source base station 5-1 or target base station 5-2, 5-3, when appropriate.

In step S1703 the source base station 5-1 (which in this example is the primary base station for the AI/ML model) transmits a handover request to the first target base station 5-2. The handover request may include a transaction ID (which may also be referred to as an ‘event ID’, and identifies a particular ‘transaction’ or particular handover of the UE) or UE ID (which may be an indication of the identity of the UE 3), and an indication of the identity of the primary base station 5-1 (e.g. primary base station ID, or any other suitable type of indication for identifying the node to which the feedback is to be transmitted, such as an indication that the handover request is being transmitted by the primary base station 5-1 that hosts the AI/ML model).

The transaction ID or UE ID can be used to associate feedback for the AI/ML model with the UE 3. When feedback is returned to the source base station 5-1 in association with the transaction ID or UE ID, the source base station 5-1 is therefore able to determine that the feedback corresponds to mobility information for that particular UE 3. The transaction ID could also be used by the target base station to determine that the feedback is to be transmitted to the source base station 5-1.

The indication of the identity of the primary base station can be used by other network nodes (e.g. the first target base station 5-2 or the second target base station 5-3) to determine which network node the feedback is to be transmitted to. The indication of the identity of the primary network node/function enables other network nodes/functions to determine which network node/function is the primary network node/function for AI/ML model for the UE 3.

The handover request message transmitted in step S1703 may also include any of the information regarding the predicted mobility of the UE 3 for the handover request message described above (e.g. as described above with reference to the Inter-base station scenario, Inter-DU scenario, and NG handover scenario). For example, the handover request may include the predicted mobility information, the AI/ML model identity, prediction accuracy, and/or AI model inputs.

In step S1704 the first target base station 5-2 transmits a handover request acknowledgement to the source base station 5-1.

In step S1705 the source base station 5-1 transmits RRC reconfiguration information (which may be referred to as configuration information for the handover) to the UE 3 for the handover. The RRC reconfiguration information may include an indication to the UE 3 to include an indication of an additional measurement result in a subsequent transmission to the first target base station 5-2 (e.g. in the RRC reconfiguration complete message transmitted in step S1706). The indication to the UE 3 to include the indication of the additional measurement result may be referred to as an AI mobility enhancement report indication. In this example, the UE 3 includes the indication of the additional measurement result in the RRC reconfiguration complete message of step S1706 if an additional measurement was performed after the measurement report was transmitted to the source base station in step S1702 (illustrated by the dashed box in FIGS. 12 and 13). Therefore, measurement information corresponding to a measurement obtained by the UE 3 before the handover is transmitted to at least one of the base stations, and can be fed back to the primary base station (e.g. to determine whether a decision to handover the UE to the target base station 5-2 was made appropriately or correctly, for example at an appropriate time (e.g. as part of the performance monitoring step of FIG. 9). The target base station 5-2 may use the information to improve a handover decision process at the target base station 5-2). Whilst in this example the AI mobility enhancement report indication is transmitted to the UE 3 in the RRC reconfiguration message, the indication may alternatively be transmitted to the UE 3 in any other suitable transmission (e.g. in a dedicated transmission after receiving the handover request acknowledgement from the target base station 5-2, and before transmitting the RRC reconfiguration message to the UE 3).

In step S1706 the UE 3 transmits the RRC reconfiguration complete message to the first target base station 5-2. The UE 3 also includes the additional measurement report, as indicated by the source base station 5-1 in the RRC reconfiguration message of step S1705.

In step S1707 the first target base station 5-2 feeds back mobility information for the AI/ML mobility model to the source base station 5-1 (that is the primary base station for the AI/ML mobility model). The information transmitted in step S1701 may be, for example, information indicating the actual mobility (e.g. trajectory) of the UE 3 after the handover. As described above, the mobility information that is fed back to the primary base station 5 may be at the cell level, beam level, TA level, RNA level, or at any other level of granularity or precision. If the indication of the additional measurement result was received at the first target base station 5-2 from the UE 3 in step S1706, then the first target base station 5-2 includes the indication of the further measurement result in the information that is transmitted to the source base station 5-1. In this example the UE mobility information is transmitted to the source base station 5-1 I association with the transaction ID or UE ID received in step S1703, so that the source base station 5-1 can identify which UE 3 the feedback information relates to.

In step S1708 the first target base station 5-2 transmits a handover request to a second target base station 5-3. The first target base station 5-2 may determine to transmit the handover request, for example, based on a mobility prediction received from the primary base station 5-1 in step S1703 (e.g. indicating that the UE 3 is likely to move into an area of coverage provided by a cell or beam of the second target base station 5-3). As described above for step S1703, first target base station 5-2 includes the transaction ID or UE ID, and includes the indication of the identity of the primary base station 5-1 in the handover request message. Therefore, the second target base station 5-2 is able to determine which base station is the primary base station 5-1, and is able to transmit any subsequent feedback information for the AI/ML model for the UE 3 in association with the transaction ID or UE ID (so that the primary base station 5-1 is able to determine to which UE 3 the feedback relates). The first target base station 5-2 may also include any of the other information related to the AI/ML mobility model received from the source base station 5-1 in step S1703 (for example, the predicted UE mobility information, model identity, or model inputs).

In step S1709, in this example the second target base station 5-3 has a direct communication link (e.g. an Xn interface) to the source base station 5-1, and so transmits the UE mobility information feedback directly to the source base station 5-1. The second target base station 5-3 is able to identify the source base station 5-1 to transmit the feedback based on the indication of the identity of the primary base station received in step S1708 from the first target base station 5-2. As described above, the mobility information fed back to the source base station 5-1 may include an actual location or mobility of the UE 3 (e.g. at the cell or beam level), or any other suitable information related to the mobility of the UE 3 that can be used with the AI/ML model at the source base station 5 (e.g. a time duration for which the UE 3 is in a particular location).

FIG. 13 shows a modification of the method of FIG. 12, in which the second target base station 5-3 transmits the UE mobility information feedback to the source base station 5-1 via the first target base station 5-2. The second target base station 5-3 may transmit the UE mobility information feedback to the source base station 5-1 via the first target base station 5-2 because, for example, the second target base station 5-3 does not have a direct communication link with the source base station 5-1 (e.g. there is no Xn interface with the source base station 5-1).

Steps S1801 to S1808 are the same as steps S1701 to S1708 described with reference to FIG. 12, and so will not be described again here.

In step S1809 the second target base station 5-3 transmits the UE mobility information feedback to the first target base station 5-2. As described above, the information transmitted in step S1809 may be, for example, information indicating the actual mobility (e.g. trajectory) of the UE 3 after the handover to the second target base station 5-3, and the feedback information is transmitted in association with the transaction ID or UE ID (so that the primary base station 5-1 is able to determine to which UE 3 the feedback relates). The transmission of step S1809 may also include the indication of the identity of the primary base station 5-1 (but need not necessarily, since the first target base station 5-2 has already received the indication of the identity of the primary base station 5-1 in step S1803 for the handover of the same UE 3).

In step S1810 the first target base station 5-2 forwards the UE mobility information feedback to the source base station 5-1. Therefore, the source base station 5-1 (that is the primary base station for the AI/ML model and generates the mobility predictions) is able to receive the UE mobility feedback for the AI/ML model from the second target base station 5-3, even when the second target base station 5-3 does not have a direct communication link with the source base station 5-1 (e.g. if there is no Xn interface).

### Distributed AI/ML Architecture

Whilst in the examples described above with reference to FIGS. 12 and 13 the network includes a primary node/function that hosts the AI/ML model and generates the AI/ML model inferences, alternatively the AI/ML model may be distributed amongst various nodes in the network. For example, a plurality of base stations 5 may host the AI/ML model and generate inferences. Whilst this may increase the processing required at some network nodes, when the AI/ML model is distributed amongst the network nodes there is beneficially a reduction in the number of inferences that are transmitted between the nodes. For example, referring to FIG. 12, if the first target base station 5-2 is configured to generate a prediction of the mobility of the UE 3 using the AI/ML model, then then the first target base station 5-2 need not necessarily receive a mobility prediction from the source base station 5-1.

When the AI/ML model (or a plurality of AI/ML models—the same model need not necessarily be used at each base station 5) is provided at a plurality of base stations 5, the feedback information can still be provided to each of the base stations that generates inferences using the AI/ML model (for example, to verify the accuracy of the model, as described above).

### Configuration Information for AI/ML

Configuration information for an AI/ML model (which may be referred to as “AI/ML configuration information”) may be exchanged between nodes in the communication network. For example, a core network node may transmit AI/ML configuration information to a base station 5 that hosts an AI/ML model. The AI/ML configuration information may include a list of supported use cases for the AI/ML model (the AI/ML model need not necessarily be for predicting UE mobility). The supported use cases may be, for example: energy saving; traffic steering; anomaly detection; quality of experience (QoE) optimisation; mobility robustness optimisation (MRO); RAN slice service level agreement (SLA) assurance; massive multiple-input multiple-output (MIMO) beamforming optimisation; network slice subnet instance (NSSI) resource allocation; optimisation coverage and capacity optimisation (CCO); mobility load balancing (MLB); RACH optimisation; or UE transmission power optimisation. The AI/ML configuration information may include an indication of a particular AI/ML model to use for a particular use case. The AI/ML configuration information may also include an indication of whether feedback is required (e.g. from another network node, as described above, for example, with reference to step S1707 of FIG. 13). The feedback may include, for example, communication performance feedback (e.g. indicating a communication performance for communication between a UE 3 and a base station 5).

When a plurality of AI/ML models are stored at a base station (or other network node), the base station 5 may receive an indication of which of the AI/ML models to use. The base station 5 may receive (e.g. from a core network node/function) an indication that use of a particular model is to be activated or deactivated (e.g. in response to a determination in the performance monitoring step of FIG. 9-a particular AI/ML model may be deactivated if the prediction accuracy has fallen below an acceptable accuracy threshold). The base station 5 may be provided with a plurality of AI/ML models, wherein each model is for use in a particular scenario or configuration.

### Single-Sided and Two-Sided Models

An AI/ML model may be hosted at both a base station 5 and a UE 3, may be hosted at only the base station 5, or may be hosted at only the UE 3. When the AI/ML model is used at the UE 3 only, the AI/ML model may be referred to as a ‘single-sided’ model. For example, the UE 3 may host an AI/ML model for generating a time (e.g. time resource) for communication using a particular beam transmitted by the base station 5. However, even when the model is a single-sided model, it will be appreciated that the model need not necessarily be trained at the UE 3. For example, the model could be trained at the base station 5 or at another node in the network (e.g. core network node/function), and then transmitted to the UE 3 for use at the UE 3. In other words, the AI/ML model may be trained at another network node, and then transferred/deployed to the UE 3.

Alternatively, the AI/ML model may be a ‘two-sided’ model, in which an AI/ML model is hosted at the UE 3, and a corresponding AI/ML model is hosted at the base station 5 (however, the models need not necessarily be hosted at a UE 3 and a base station 5—any other suitable two network nodes could alternatively be used). The AI/ML model hosted at the UE 3 and the AI/ML model hosted at the base station 5 may be the same AI/ML model. The UE 3 can use the AI/ML model to generate a first inference, and the base station 5 can use the AI/ML model to generate a corresponding second inference. For example, the first inference may be an inference of a parameter to use for compressing data (e.g. channel state information (CSI)) to be transmitted from the UE 3 to the base station 5, and the second inference may be an inference of a parameter to use to decompress the data at the base station 5. As with the single-sided model case, the two-sided model (or models) may be trained at any suitable network node, and then transmitted to the UE 3 and the base station 5.

### AI/ML Model Acquisition

Particularly advantageous methods of AI/ML model deployment will now be described. In this example, the AI/ML model is transmitted to a UE 3, for use at the UE 3. The AI/ML model may be a two-sided model (in a case where a corresponding AI/ML model, or the same AI/ML model, is used at the base station 5), but could alternatively be an AI/ML model that is used at only the UE 3.

In this example, a broadcast transmission or a multicast transmission is used to transmit the AI/ML model to the UE 3 when the UE 3 is in the RRC idle state or the RRC inactive state. A multicast transmission and/or an RRC message (e.g. dedicated RRC message, or another new RRC message that is different from a legacy RRC message) is used to transmit the AI/ML model to the UE 3 when the UE 3 is in the RRC connected state.

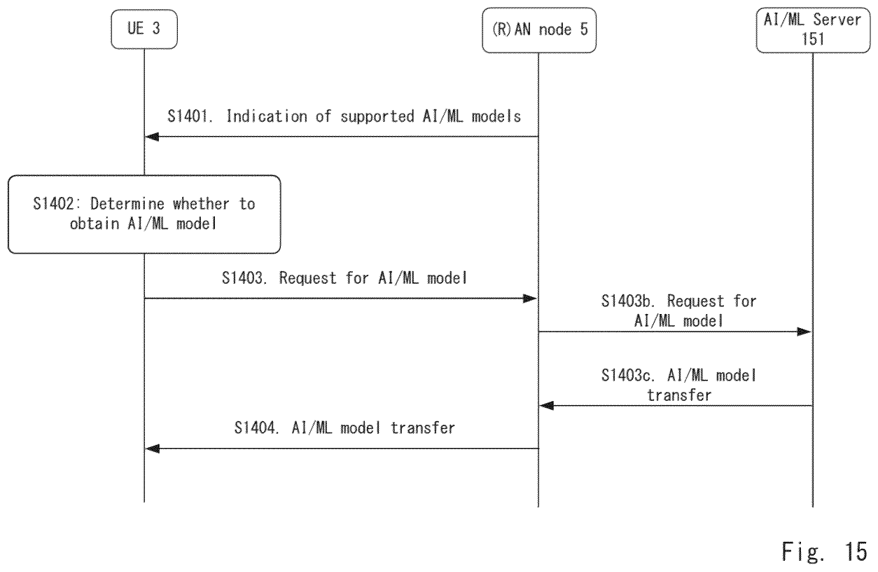

FIG. 14 shows an example of a method in which the base station 5 broadcasts an indication of supported AI/ML models.

In step S1401, the base station 5 broadcast an indication of supported AI/ML models. In this example, the indication of the supported AI/ML models is included in system information (SI) that is broadcast in a cell of the base station. The UE 3 in this example is in the RRC idle or RRC inactive state (but could alternatively be in the RRC connected state). Advantageously, therefore, the UE 3 is able to receive the information indicating which AI/ML models are supported by the base station 5, even when the UE 3 is in the RRC idle or RRC inactive state.

The broadcast SI may include a list of AI/ML model IDs and/or version numbers for the supported AI/ML models. The supported AI/ML models may be indicated per use case. For example, a first indication of the AI/ML models supported for beam management may be provided, and a second indication of the AI/ML models supported encoding/decoding CSI may also be provided. The indication of the supported AI/ML models may be broadcast periodically by the base station 5, or alternatively could be broadcast in an on-demand manner in response to a request from the UE 3. In addition, the broadcast SI may include an indication of a method for acquiring the AI/ML model (e.g., signalling-based transmission between the UE 3 and the RAN node 5, or data-based transmission between the UE 3 and an AI/ML server 151). In a case where the UE 3 is to acquire the AI/ML model from an AI/ML server 151, the identity and (IP) address of the AI/ML server 151 can also be included in the SI.

In step S1402 the UE 3 determines, based on the indication of the supported AI/ML models received from the base station 5, whether to obtain one of the supported AI/ML models. In this example, the UE 3 determines to obtain one of the models, and transmits a request for the model to the base station 5 in step S1403. Step S1403 may be performed when the UE 3 is in the RRC idle or RRC inactive state (or, as described in more detail below, as part of a transition from the RRC idle or RRC inactive state to the RRC connected state, e.g. using MSG3). In step S1404 the base station 5 transmits the requested model to the UE 3. As described in more detail below, the UE 3 may be in the RRC connected, RRC inactive or RRC idle state when receiving the AI/ML model from the base station in step S1404.

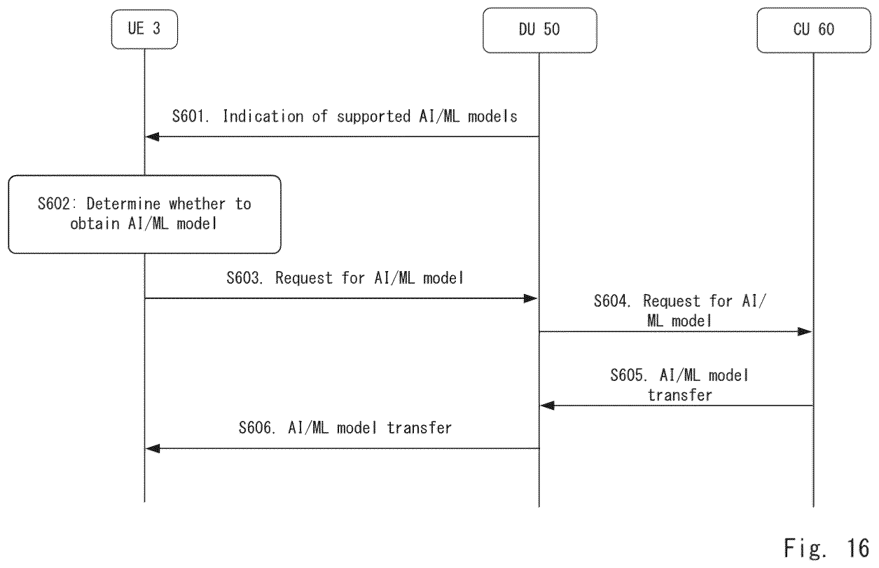

Whilst in the example of FIG. 14 the UE 3 transmits the request for the AI/ML model to the base station 5, and receives the requested AI/ML model from the base station 5, this need not necessarily be the case. The UE 3 may alternatively request and receive the AI/ML model from any other suitable node in the network (e.g. another base station 5, or a core network node/function/server) after receiving the indication of the supported AI/ML models from the base station 5. For example, FIG. 15 shows a modified version of FIG. 14 in which the UE 3 requests an AI/ML model that is stored at an AI/ML server 151. FIG. 15 includes new steps S1403b and S1403c. In step S1403b, the base station 5 transmits, to the AI/ML server 151, a request for the AI/ML model requested by the UE 3. In step S1403c, the AI/ML server 151 transmits the requested model to the base station 5, for forwarding to the UE 3 in step S1404. The forwarding of the AI/ML model via the base station 5 of steps S1403c and S1404 may be transparent to the base station 5 (e.g. the AI/ML model could be transmitted using one or more transparent containers). In a further alternative, the UE 3 may obtain the AI/ML model from the AI/ML server 151 via an AMF 10-1, for example using NAS based signalling. For example, rather than transmitting the request for the AI/ML model to the base station 5, the UE 3 could transmit the request for the AI/ML model to the AMF 10-1. The AMF 10-1 could then request the model from the AI/ML server 151, and forward the AI/ML model from the AI/ML server 151 to the UE 3. In another alternative, the UE 3 could request the AI/ML model from the base station 5, which could then request the AI/ML model from the AI/ML server 151. However, rather than transmitting the AI/ML model to the UE 3 via the base station that received the request, the AI/ML model could be transmitted to the UE 3 via the AMF 10-1 (using corresponding NAS signalling).

When the UE 3 requests an AI/ML model that is stored at the AI/ML server 151, the UE's 3 acquisition of the AIML model from the server 151 may be transparent to the radio network from a signalling perspective, since the AI/ML model transfer from the server 151 to the UE 3 can be normal data transmission, or the like. However, when the UE 3 establishes an RRC connection with the radio network for such data transmission, it may include the RRC establishment cause (e.g., for AI/ML model transfer) and/or the AI/ML server address in the RRC message. The (R)AN node 5 may forward the information to the core network. Beneficially, the information helps the RAN node 5 and/or the core network node to establish the subsequent user plane data tunnel for AI/ML model transmission between the server 151 and the UE 3.

The determination of whether to obtain an AI/ML model in step S1402 may be based on a comparison of an AI/ML model stored at the UE 3 and the supported AI/ML models. For example, the base station 5 may provide an indication of model versions of the supported AI/ML models in the information broadcast in step S1401, and the UE 3 may compare a version number of a model stored at the UE 3 to a version number of one of the supported models and determine that a newer version of a model is to be obtained. Alternatively, the UE 3 may determine that the UE 3 does not store an AI/ML model for a particular use case (e.g. for encoding CSI), and therefore determine to obtain the supported AI/ML model for that use case. Additionally, or alternatively, the UE 3 may determine to transmit the request for the AI/ML model based on a timer. Advantageously, the use of a timer UE 3 enables the UE 3 to request a more recent version of the AI/ML model, even if the UE 3 has not received the indication of the supported AI/ML models of step S1401 (for example, the UE 3 may transmit a request for the most recent version of an AI/ML model stored at the UE 3 to the base station 5 based on the timer, irrespective of whether the UE 3 has received the transmission of step S1401). In a further alternative, the base station 5 may determine to transmit an updated version of a model to the UE 3 in step S1404 based on a timer. Advantageously, therefore, the base station 5 is able to provide the UE 3 with a more recent version of the AI/ML model even if the base station 5 has not received a request for the more recent version of the AI/ML model from the UE 3. This can be particularly beneficial for two-sided models, for which the version of the model at the UE 3 (e.g. for encoding CSI) may need to match, or correspond to, the version of a model at the base station 5 (e.g. for decoding CSI). By transmitting the request for the AI/ML model in step S1403 or the transfer of the model in step S1404 based on a timer, the risk of the model at the UE 3 becoming mismatched with the model at the base station 5 is reduced. It will be appreciated that even when a timer is used for the transmission of S1403, the UE 3 may nevertheless determine to transmit a request for one or more AI/ML modes even if the time has not yet expired (e.g. based on the information received in step S1401, as described above).

The UE 3 may perform a random access procedure to request the AI/ML model from the base station 5 (e.g. the RA procedure described above with reference to FIG. 6). In this example, MSG3 transmitted from the UE 3 to the base station 5 in the RA procedure advantageously includes an RRC establishment cause that indicates that the UE 3 is requesting an AI/ML model (e.g. by including an indication of the identity of the requested AI/ML model, or an indication that the UE 3 is to enter the RRC connected state to download an AI/ML model from the base station 5). The UE 3 may use the RA procedure to request the AI/ML model in both the example of FIG. 14 in which the requested AI/ML model is initially stored at the base station 5, or in the method of FIG. 15 in which the AI/ML model is initially stored at the AI/ML server 151 (or any other suitable network node).

Whilst the use of MSG3 and the RRC establishment cause provides a particularly efficient mechanism for indicating that the UE 3 is requesting an AI/ML model, the indication could alternatively be provided in any other suitable transmission from the UE 3 to the base station 5. For example, the UE 3 may use a new RRC message (e.g. dedicated RRC message) to indicate that the UE 3 is requesting an AI/ML model. Any other suitable method of obtaining the AI/ML model could alternatively be used—the UE 3 need not necessarily initiate the RA procedure in order to obtain the model.

In a further alternative, rather than the UE 3 requesting the AI/ML model (entering the RRC connected state to receive the model) in response to the determination of step S1402, the UE 3 may simply wait until the UE 3 is next in the RRC connected state before obtaining the AI/ML model from the base station 5. In another alternative, the UE 3 may receive the AI/ML model when the UE 3 is in the RRC idle or RRC inactive state, rather than entering the RRC connected state to receive the AI/ML model. In this case, the base station 5 transmits an indication of the communication resources (e.g. time and frequency resources) for use by the UE 3 to receive the AI/ML model whilst the UE 3 is in the RRC idle or RRC inactive state.

The AI/ML model may be transmitted from the base station 5 to the UE 3 in step S1404 using an RRC message or a user plane transmission (e.g. using a DRB). Advantageously, a priority (e.g. transmission priority) can be assigned for the DRB or logical channel that carries the AI/ML model. As described above, a logical channel may be assigned (e.g. by the base station 5) an index that indicates a priority for transmission of the logical channel, and/or a prioritised bit rate (PBR). The priority or PBR configured for the DRB or LCH that carries the AI/ML model may depend, for example, on the type of AI/ML model that is requested (e.g. the use case of the AI/ML). For example, the DRB or LCH used to transmit an AI/ML model for use as part of a handover procedure could be assigned a higher priority (or higher PBR) than if the AI/ML model were for use in a beam prediction procedure.

From an air interface perspective, when AIML model transfer is subject to user plane transmission as described above, it may be different from conventional user plane (UP) transmission. Conventional UP transmission requires two, or multiple, portions-based transmission (an air interface plus backhaul-based fixed network), e.g. DRB over the air interface plus a data tunnel established between the base station 5 and a UPF in the core network that bridges the data towards a data server. In this conventional method of UP transmission, the base station 5 is not the producer of the data, and instead it is a ‘consumer’ of the data, since the base station simply converts the one or more QoS flows into DRB at the SDAP layer, to support the data transmission for a particular QoS service in terms of data radio bearer over air interface. However, the present inventors have realised that for the case of AI/ML model transfer, this traditional UP transmission can advantageously be modified: the base station 5 can be the data producer, in a case where the base station 5 itself holds the AIML model, ready for transfer to the UE. When the base station 5 determines to transfer the AI/ML model to the UE 3 via a UP based channel, the base station 5 can configure the data content of AI/ML model as a Service Data Unit (SDU) to the PDCP layer, which can be viewed as a special Data Radio Bearer. In this case, the data of the AI/ML model will not be carried by the SDAP layer, in contrast to the conventional method.

Step S1404 of FIGS. 14 and 15 may comprise transmitting the AI/ML model to the UE 3 using a dedicated radio bearer (e.g. a bearer other than a legacy SRB/DRB). A new logical channel (e.g. dedicated logical channel) could be used to transmit the AI/ML model. The logical channel could be assigned a priority and/or PBR as described above, or alternatively the logical channel may simply not be multiplexed with other logical channels and instead could be transmitted separately.

FIG. 16 shows an example of how the requested AI/ML model can be obtained by the UE 3 when the requested AI/ML model is initially stored at a CU 60 of a distributed base station. Steps S601 to S603 are the same as steps S1401 to S1403 described above, and so will not be described again here. In step S604 the DU 50 transmits a request for the AI/ML model requested by the UE 3 to the CU 60, and in step S605 the CU 60 transmits the AI/ML model to the DU 50. Step S606, in which the DU 50 transmits the requested AI/ML model to the UE 3, is the same as step S1404 of FIGS. 14 and 15.

A new (e.g. dedicated) F1-application protocol (AP) message or procedure could be used to transmit the AI/ML model from the CU 60 to the DU 50 in step S605. Moreover, The CU 60 could also transmit, to the DU 50, an indication of the supported AI/ML models to be broadcast by the DU 50 in step S601. The indication of the supported AI/ML models (e.g. model IDs) could be transmitted from the CU 60 to the DU 50 using an F1-AP message (e.g. a dedicated F1-AP message). The DU 50 is therefore able to determine the indication of the supported AI/ML models to be broadcast in step S601.

As described above, the indication of the supported AI/ML models may be transmitted in step S1401 (or step S601) using system information broadcast in a cell of the base station 5. A new SIB could be used to transmit the indication of the supported AI/ML models. This SIB may be referred to as an ‘AI/ML SIB’. SIB1 could be used to provide an indication that the AI/ML SIB is available for broadcast in the cell (the AI/ML SIB may be on-demand SI, that is transmitted in response to a request from the UE 3 that is not shown in the FIG. 14 but is transmitted by the UE 3 before step S1401). The MIB and SIB1 may provide the UE 3 with an indication of scheduling information for receiving and decoding the dedicated AI/ML SIB. The AI/ML SIB may include the model IDs of the supported (or ‘available’) AI/ML models. As described above, the AI/ML SIB may indicate the supported AI/ML mods per use case.

The AI/ML SIB may be broadcast periodically (e.g. according to a predetermined periodic pattern), or alternatively may be provided ‘on-demand’, for example in response to the request from a UE 3. SIB1 can be used to indicate to the UE 3 whether the AI/ML SIB is transmitted periodically or whether it is available on-demand.

When the AI/ML SIB is available in an on-demand manner, the base station 5 provides an indication of the availability of the AI/ML SIB, or information indicating the supported AI/ML model IDs for a particular feature (e.g., beam management) in the system information SIB1. The UE 3 may be configured to request the AI/ML SIB using message 1 (MSG1), which may be referred to as a MSG1-based on-demand SI request for the AI/ML SIB, or message 3 (MSG3), which may be referred to as a MSG3-based on-demand SI request for the AI/ML SIB. The UE 3 may also use another type of uplink message to indicate that the UE 3 is requesting information regarding the one or more AI/ML models supported by the base station (e.g., AI/ML model IDs). When the network receives the UE's 3 request for the information (e.g., AI/ML IDs), the network broadcasts the supported AI/ML information (e.g. AI/ML model IDs) for the one or more features as requested by the UE 3 (e.g. using a system information block, AI/ML SIB). The UE 3 can then acquire the AI/ML information by receiving and decoding the broadcasted message (e.g. the AI/ML SIB). These steps may be performed before and/or during step S1401 of FIG. 14 and FIG. 15.

In the examples described above with reference to FIGS. 14 to 16, the UE 3 may request a single AI/ML model, or alternatively could request a plurality of AI/ML models in step S1403 (or step S603).

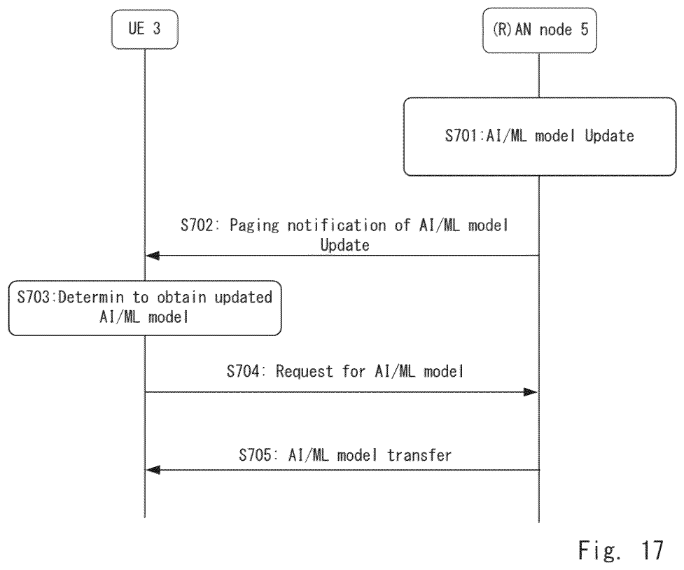

FIG. 17 shows a modification of the method of FIG. 14, in which the network is configured to use a paging transmission to notify one or more UEs 3 of an update to an AI/ML model.

In step S701 the base station 5 obtains an updated AI/ML model. The updated AI/ML model may be generated at the base station 5, or the updated AI/ML model may be received from another node in the network (e.g. from the AI/ML server 151, or a core network node/function). In step S702 the base station transmits a paging transmission that includes an indication that the AI/ML model has been updated. The paging transmission may be a group paging transmission (a paging transmission intended for reception by a particular group of UEs 3).

The paging transmission of step S702 may include an indication of where the UE 3 is to obtain the updated AI/ML model. For example, if the updated AI/ML model is stored at the AI/ML server 151, then the paging transmission may provide an indication that the UE 3 is to obtain the updated AI/ML model directly from the AI/ML server 151 (or from any other suitable network node). The paging transmission may also include an indication of the UEs 3 that are to obtain the updated AI/ML model (e.g. an indication of the identity of the UEs 3 that are to obtain the updated AI/ML model).

The paging transmission may include an indication that the paging is for notification of an updated AI/ML model. For example, the paging transmission may include a cause value that indicates that the paging is for notification of an updated AI/ML model. The paging transmission may include an indication of the identity of the updated AI/ML model (e.g. model ID number), and/or a version number of the updated AI/ML model.

In step S703 the UE 3 determines to obtain the updated AI/ML model based on the information received in step S702. For example, the UE 3 may determine to obtain the updated AI/ML model based on a difference between a version number of the model stored at the UE 3 and a version number of the updated AI/ML model. Alternatively, the UE 3 may determine to obtain the updated AI/ML model based on an explicit indication in the paging transmission of step S702 that the UE 3 is to obtain the updated AI/ML model. Steps S704 and S705 are the same as steps S1403 and S1404 described above with reference to FIG. 14, and so will not be described again here.

Whilst in this example the paging transmission is used to notify one or more UEs 3 that the AI/ML model has been updated, alternatively (or additionally) the paging transmission could be used to request an identity of an AI/ML model stored at the UE 3, in which case the UE 3 transmits an indication of the AI/ML model stored at the UE 3 to the base station 5 after receiving the request. Alternatively, or additionally, the paging transmission could be used to request AI/ML model history information, or other information regarding the status of the AI/ML model, from the UE 3 (e.g. execution history for the model), in which case the UE 3 transmits the AI/ML model history information to the base station 5 after receiving the request.

### Area-Based AI/ML Models

Methods related to area-based AI/ML models will now be described. An AI/ML model may be for use in a particular area or location. An AI/ML model may be for use in a particular cell or group of cells, which may be operated by one or multiple base stations 5. For example, an AI/ML model may be for use in a group of cells for beam management.

The area in which an AI/ML model is to be used could be defined as one or more cells, one or more RAN-based notification areas (RNAs), or registration areas (RAs). However, it will be appreciated that any other suitable area for use of the AI/ML model could be defined. The area within which the AI/ML model is to be used for a particular function (e.g. beam management, CSI encoding/decoding, or mobility) may be referred to as an AI/ML model function area.

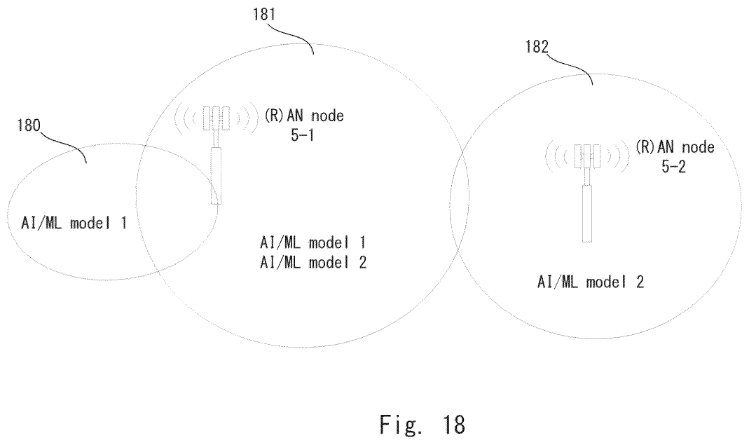

A cell provided by a base station 5 may be part of a plurality of AI/ML model function areas. FIG. 18 shows an example in which a first base station 5-1 provides a first cell 180 and a second cell 181, and a second base station 5-2 provides a third cell 181. In this example, a first AI/ML model is for use in the first cell 180 and the second cell 181 for a first function (e.g. beam management). The AI/ML model function area of the first AI/ML model therefore comprises the first cell 180 and the second cell 181. A second AI/ML model is for use in the second cell 181 and the third cell 182 for a second function (e.g. for CSI encoding/decoding). The AI/ML model function area of the second AI/ML model therefore comprises the second cell 181 and the third cell 182.

In this example, the second cell 181 belongs to both the AI/ML model function area of the first AI/ML model and the AI/ML model function area of the second AI/ML model. In this example, one AI/ML model is used for use for each function in each area. Alternatively, more than one AI/ML model may be available for use for a function in a particular area (e.g. more than one AI/ML model may be available for UE mobility inferences in a particular cell).

In this example, the base station 5-1 is configured to transmit a broadcast transmission in the first cell 180 that indicates that the first cell 180 belongs to the AI/ML model function area of the first AI/ML model, and to transmit a broadcast transmission in the second cell 181 that indicates that the second cell belongs to the both the AI/ML model function area of the first AI/ML model and the AI/ML model function area of the second AI/ML model. The indication of which AI/ML model function areas the cell belongs to may be referred to as AI/ML model area information. Therefore, a UE 3 in a cell of the base station 5-1 is able to determine which AI/ML model to use for a particular function in that cell. The base station 5 may be configured to indicate, in the broadcast transmission, the model function areas to which the cell belongs per AI/ML model, or per function. For example, the base station 5 may support two AI/ML features/functions, with AI/ML model X used for the first function, and AI/ML model Y used for the second function. From a network deployment perspective, AI/ML model X for the first function can belong to Area N (which could be, for example, a relatively small area), and AI/ML model Y for the second feature could belong to Area M (which could be, for example, a relatively large area). The broadcast information could indicate that the cell supports AI/ML models X and Y, could indicate that the cell supports the first function with AI/ML model X and second function with AI/ML model Y, or alternatively could indicate that the cell is part of the corresponding areas N and M (for different models).

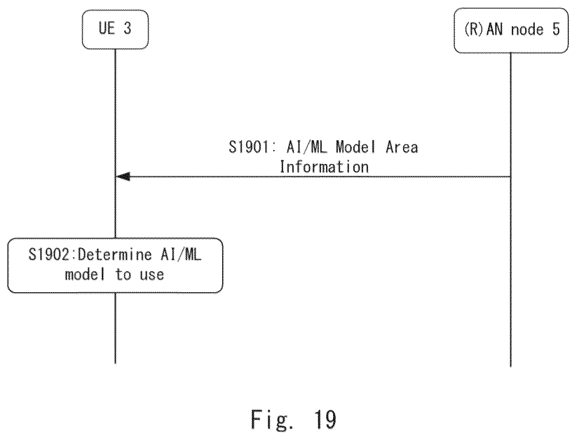

FIG. 19 illustrates a method in which the AI/ML model area information is received by a UE 3. In step S1901 the base station 5 transmits (broadcasts) the AI/ML model area information in a cell of the base station 5, and the information is received by a UE 3 in the cell.

In step S1902 the UE 3 determines, based on the AI/ML model area information, to use a particular AI/ML model. For example, when the UE 3 is in the second cell 181 of FIG. 18 and receives AI/ML model area information that the first AI/ML model is for use for the first function in the second cell 181, the UE 3 determines to use the first AI/ML model for the first function in the second cell 181. If the UE 3 does not support an AI/ML model indicated in the AI/ML model area information, then the UE 3 may simply ignore the AI/ML model area information. After the UE 3 determines to use a particular AI/ML model, the UE 3 may obtain the AI/ML model (if it is not already stored at the UE 3) according to any of the methods described above (e.g. any of the methods illustrated in FIGS. 14 to 17). For example, the UE 3 may use a random access procedure including MSG3 as part of a method for obtaining the AI/ML model, as described above. As described above, the UE 3 may obtain the AI/ML model either directly from the base station 5, or from another node in the network (e.g. from an AI/ML server 151 (via an AMF 10-1), from an operations, administration, and maintenance server (OAM), or from any other suitable node/function in the network).

Alternatively, rather than the AI/ML model area information including an indication of which AI/ML model is supported for a particular function, the AI/ML model area information may simply include an indication that a particular function is supported in the area. In this case, after receiving the AI/ML model area information, the UE 3 may determine to obtain system information broadcast in the cell to determine which AI/ML model to use. For example, as described above, the UE 3 may request an on-demand SIB that includes an indication of the AI/ML models that are supported for particular functions in the cell. The UE 3 may determine to obtain the AI/ML model after moving into a new cell and receiving the broadcast transmission of step S1901 (e.g. following a cell reselection procedure), or if the AI/ML for use for a particular function in the cell is changed (which the UE 3 can also identify based on the broadcast transmission of step S1901). The UE 3 may be configured to periodically check for transmission of the AI/ML model area information by the base station 5 (e.g. by receiving and decoding the corresponding SI) based on a timer. Similarly, the base station 5 may be configured to periodically broadcast the AI/ML model area information in one or more cells based on a timer.

If the AI/ML model supported for use for a function in a particular area is updated, then the UE 3 may obtain the updated model using any of the methods described above (e.g. the method described with reference to FIG. 17).

The UE 3 may store a plurality of AI/ML models that could be used for a particular function, and the UE 3 may select one of the plurality of AI/ML models based on the AI/ML model area information received in step S1901. For example, the UE 3 may store a first AI/ML model for beam management in a first area, and a second AI/ML model for beam management in a second area, and may determine to use the first AI/ML model based on an indication, in the AI/ML model area information, that the cell belongs to the first area. If the cell belongs to both the first area and the second area, then the UE 3 may provide an indication to the network (e.g. to the base station 5) of whether the first AI/ML model or the second AI/ML model is to be used (e.g. which model is preferred by the UE 3). Advantageously, therefore, for two-sided models a mismatch between the model used at the base station 5 and the model used at the UE 3 can be avoided when a plurality of models are supported for the same function in a particular area. The UE 3 may provide an indication of which AI/ML model is to be used (or which AI/ML is preferred for use) using the first RRC message transmitted to the base station 5 after the UE 3. The UE 3 may include the indication in MSG3 described above with reference to FIG. 6.

In the example of FIG. 18, mobility of the UE 3 may occur from the second cell 181 to the third cell 182. Whilst in the second cell 181, the UE 3 uses the first AI/ML model for the first function. However, in this example the third cell 182 does not support the first function. Therefore, the UE 3 may determine not to use (or to disable) the first AI/ML model for the first function after the UE 3 has moved into the second cell 5-2. For example, the UE 3 may determine to not use (or to disable) the first AI/ML model in response to receiving a broadcast transmission from the second base station 5-2 that indicates the AI/ML models supported in the third cell 182 (or the AI/ML model function areas to which the third cell 182 belongs). The UE 3 may also determine not to use (or to disable) the first AI/ML model in the third cell 182 even if the UE 3 has not received the broadcast transmission from the second base station 5-2. For example, the UE 3 may determine not to use (or to disable) the first AI/ML model in the third cell 182 as a default option, and only determine to use the first AI/ML model in the third cell if the UE 3 receives an indication that the first AI/ML model can be used in the third cell 182). Advantageously, therefore, use of an unsupported AI/L model or AI/ML model function can be avoided, even when the base station 5-2 is a legacy base station that may not support transmission of AI/ML related information, such as the transmission of step S1901 of FIG. 19.

### Model Updates and RRC State Transitions

When the UE 3 transitions from the RRC idle state or the RRC inactive state to the RRC connected state, the UE 3 may use layer 1 (L1), layer 2 (L2) or layer 3 (L3) signalling to indicated to the network which AI/ML models are stored at the UE 3 (e.g. by transmitting the associated AI/ML model IDs). The UE 3 may also use the L1/L2/L3 signalling to provide an indication to the network of the versions of the AI/ML models that are stored at the UE 3. The L1/L2/L3 signalling may also be used to provide an indication of history information associated with an AI/ML model (e.g. the execution history of the model).

Based on the L1/L2/L3 signalling the network (e.g. the base station 5) may determine a particular AI/ML model that is to be used for a particular function. For example, the base station 5 may determine, based on the L1/L2/L3 signalling, that the UE 3 stores an AI/ML model that is also supported at the base station 5, and may therefore determine to use the AI/ML model for a particular function (e.g. beam management, or encoding/decoding of CSI). The base station 5 may determine to transmit the AI/ML model to the UE 3 if it is not already stored at the UE 3, or may determine to transmit, to the UE 3, a different version of an AI/ML model stored at the UE 3. The base station 5 may transmit the AI/ML model to the UE 3 following the transition of the UE 3 to the RRC connected state (e.g. immediately following the transition of the UE 3 to the RRC connected state).

In order to avoid a mismatch between the AI/ML model used at the UE 3 and the AI/ML model used at the base station 5 (for a two-sided AI/ML model), the base station may be configured not to use the AI/ML model until the AI/ML model has been transmitted to the UE 3, or until the base station 5 has received an acknowledgement from the UE 3 that the AI/ML model has been obtained. For example, the base station 5 may use a non-AI/ML algorithm for CSI compression/decompression. The base station 5 may control the activation of use of the AI/ML model at the UE 3 (e.g. for a particular function) using DCI or a medium access control (MAC) control element (CE).

The base station 5 may also receive, in the L1/L2/L3 signalling, information indicating a performance of an AI/ML model used at the UE 3. The model performance information may be the model performance feedback of FIG. 8, or may be information for use in the performance monitoring step of FIG. 9, for example.

When the UE 3 transitions from the RRC connected state to the RRC idle state or the RRC inactive state, the UE 3 may be configured to continue to store one or more AI/ML models that are stored at the UE 3. The UE 3 may be configured to continue to store the AI/ML models for a predefined period, for example based on a timer. However, it will be appreciated that the UE 3 may be configured to delete or overwrite an AI/ML model stored in the memory of the UE 3 if the UE 3 receives a further AI/ML model and does not have sufficient memory to store both of the models. When the UE 3 is configured to continue to store one or more AI/ML models after the UE 3 transitions from the RRC connected state to the RRC idle state or the RRC inactive state, it will be appreciated that the AI/ML is not part of the UE context for the RRC connected state, since the UE context for the RRC connected state is removed after the UE transitions out of the RRC connected state to the RRC idle or RRC inactive state.

### RRC Procedures

RRC procedures may be used for AI/ML related queries transmitted between the network and the UE 3 when the UE 3 is in the RRC connected state. For example, the network may request (e.g. via the base station 5), using an RRC message (e.g. a dedicated RRC message, or other non-legacy RRC message), information indicating an identity of one or more AI/ML models stored at the UE 3. The network may request information indicating the identity of one or more AI/ML models, for a particular function or feature, stored at the UE 3. The UE 3 may transmit a corresponding RRC message to the base station 5 that includes the requested information. For example, the UE 3 may transmit an RRC message to the base station 5 that includes an indication of an AI/ML model ID of an AI/ML model stored at the UE 3.

Similarly, the UE 3 may request AI/ML related information from the network (e.g. via the base station 5) using an RRC message (e.g. a dedicated RRC message, or other non-legacy RRC message). For example, the UE 3 may request an identity of an AI/ML model supported by the base station 5 for a particular function, or may request a version number of an AI/ML model available at the base station 5 (e.g. the UE 3 may request the current version number of an AI/ML model, in order to obtain the most recent version of the model). The base station 5 may then transmit a corresponding RRC message to the UE 3 that includes the requested information (e.g. including an indication of an AI/ML model ID of an AI/ML model stored at the base station 5).

### User Equipment

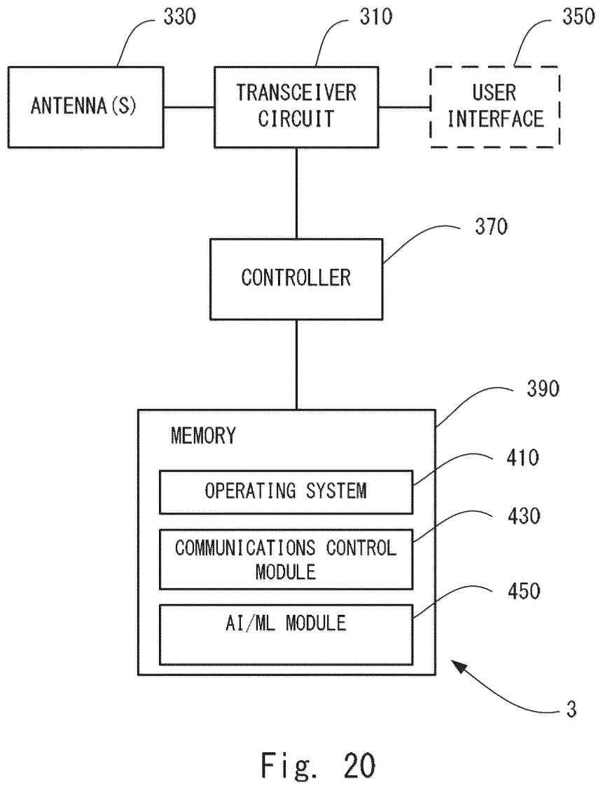

FIG. 20 is a schematic block diagram illustrating the main components of a UE 3 as shown in FIG. 1.

As shown, the UE 3 has a transceiver circuit 310 that is operable to transmit signals to and to receive signals from a base station 5 via one or more antenna 330 (e.g., comprising one or more antenna elements). The UE 3 has a controller 370 to control the operation of the UE 3. The controller 370 is associated with a memory 390 and is coupled to the transceiver circuit 310. Although not necessarily required for its operation, the UE 3 might, of course, have all the usual functionality of a conventional UE 3 (e.g. a user interface 350, such as a touch screen/keypad/microphone/speaker and/or the like for, allowing direct control by and interaction with a user) and this may be provided by any one or any combination of hardware, software, and firmware, as appropriate. Software may be pre-installed in the memory 390 and/or may be downloaded via the telecommunications network or from a removable data storage device (RMD), for example.

The controller 370 is configured to control overall operation of the UE 3 by, in this example, program instructions or software instructions stored within memory 390. As shown, these software instructions include, among other things, an operating system 410, a communications control module 430, and an AI/ML module 450.

The communications control module 430 is operable to control the communication between the UE 3 and its one or more serving base stations 5 (and other communication devices connected to the base station 5, such as further UEs and/or core network nodes). The communications control module 430 is configured for the overall handling uplink communications via associated uplink channels (e.g. via a physical uplink control channel (PUCCH), random access channel (RACH), and/or a physical uplink shared channel (PUSCH)) including both dynamic and semi-static signalling (e.g., SRS). The communications control module 430 is also configured for the overall handling of receipt of downlink communications via associated downlink channels (e.g. via a physical downlink control channel (PDCCH) and/or a physical downlink shared channel (PDSCH)) including both dynamic and semi-static signalling (e.g., CSI-RS). The communications control module 430 is responsible, for example: for determining where to monitor for downlink control information (e.g., the location of CSSs/USSs, CORESETs, and associated PDCCH candidates to monitor); for determining the resources to be used by the UE 3 for transmission/reception of UL/DL communications (including interleaved resources and resources subject to frequency hopping); for managing frequency hopping at the UE side; for determining how slots/symbols are configured (e.g., for UL, DL or SBFD communication, or the like); for determining which one or more bandwidth parts are configured for the UE 3; for determining how uplink transmissions should be encoded; for applying any SBFD specific communication configurations appropriately; and the like. The communications control module 430 may be configured to control communications in accordance with any of the methods described above (for example, to transmit a measurement report according to any of the methods described above).

The AI/ML module 450 is operable to control the use of an AI/ML model at the UE 3 (e.g. to generate one or more inferences using the model). The AI/ML module 450 may be configured to perform any of the AI/ML related functions of the UE 3 of any of the methods described above.

### Base Station

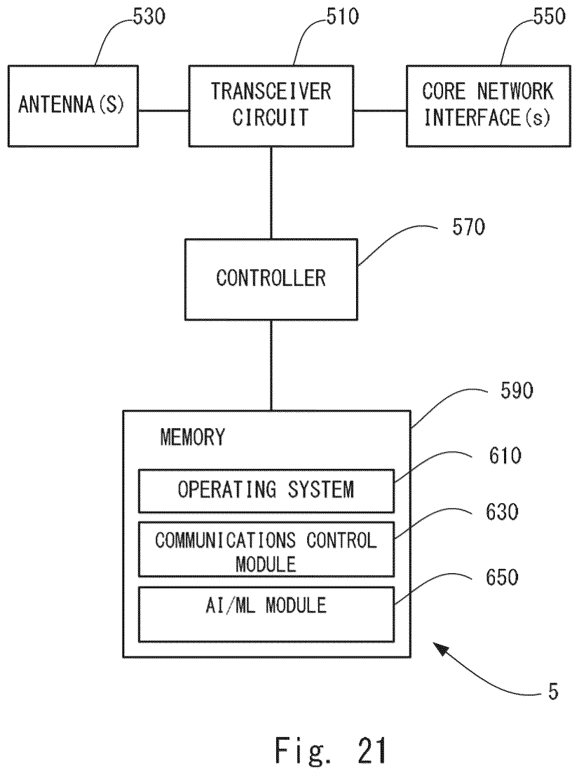

FIG. 21 is a schematic block diagram illustrating the main components of the base station 5 for the communication system 1 shown in FIG. 1. As shown, the base station 5 has a transceiver circuit 510 for transmitting signals to and for receiving signals from the communication devices (such as UEs 3) via one or more antenna 530 (e.g. a single or multi-panel antenna array/massive antenna), and a core network interface 550 (e.g. comprising the N2, N3 and other reference points/interfaces) for transmitting signals to and for receiving signals from network nodes in the core network 7. Although not shown, the base station 5 may also be coupled to other base stations via an appropriate interface (e.g. the so-called ‘Xn’ interface in NR). The base station 5 has a controller 570 to control the operation of the base station 5. The controller 570 is associated with a memory 590. Software may be pre-installed in the memory 590 and/or may be downloaded via the communication system 1 or from a removable data storage device (RMD), for example. The controller 570 is configured to control the overall operation of the base station 5 by, in this example, program instructions or software instructions stored within memory 590.

As shown, these software instructions include, among other things, an operating system 610 and a communications control module 630.

The communications control module 630 is operable to control the communication between the base station 5 and UEs 3 and other network entities that are connected to the base station 5. The communications control module 630 is configured for the overall control of the reception and decoding of uplink communications, via associated uplink channels (e.g. via a physical uplink control channel (PUCCH), a random-access channel (RACH), and/or a physical uplink shared channel (PUSCH)) including both dynamic and semi-static signalling (e.g., SRS). The communications control module 630 is also configured for the overall handling the transmission of downlink communications via associated downlink channels (e.g. via a physical downlink control channel (PDCCH) and/or a physical downlink shared channel (PDSCH)) including both dynamic and semi-static signalling (e.g., CSI-RS). The communications control module 630 is responsible for managing full duplex (e.g., SBFD) communication including, where appropriate, the segregation of UL and DL communication via different physical antenna elements. The communications control module 630 is responsible, for example: for determining where to configure the UE 3 to monitor for downlink control information (e.g., the location of CSSs/USSs, CORESETs, and associated PDCCH candidates to monitor); for determining the resources to be scheduled for UE transmission/reception of UL/DL communications (including interleaved resources and resources subject to frequency hopping); for managing frequency hopping at the base station side; for configuring slots/symbols appropriately (e.g., for UL, DL or SBFD communication, or the like); for configuring one or more bandwidth parts for the UE 3; for providing related configuration signalling to the UE 3; and the like. The communications control module 43 may be configured to control communications in accordance with any of the methods described above (for example, to receive or transmit UE 3 mobility information, or a handover request).

The AI/ML module 630 may be configured to perform any of the AI/ML related functions of the UE 3 of any of the methods described above. The base station 5 may be configured to train or re-train the AI/ML model as described above (for example, in response to UE mobility information that is fed back to the base station 5 from another node in the network, such as another base station 5).

### Core Network Node/Function

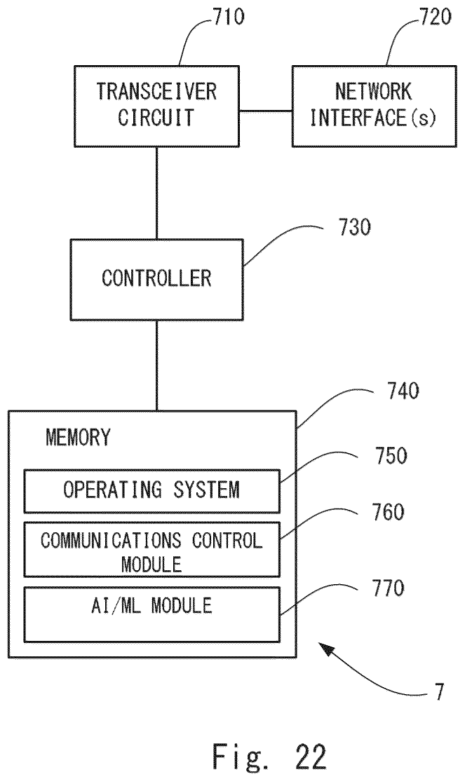

FIG. 22 is a block diagram illustrating the main components of a core network node or function, such as the AMF, CPF, the UPF, the SMF or OAM. As shown, the core network function includes a transceiver circuit 710 which is operable to transmit signals to and to receive signals from other nodes (including the UE 3, the base station 5, and other core network nodes) via a network interface 720. A controller 730 controls the operation of the core network function in accordance with software stored in a memory 740. The software may be pre-installed in the memory 740 and/or may be downloaded via the communication system 1 or from a removable data storage device (RMD), for example. The software includes, among other things, an operating system 750, and a communications control module 760.

The communications control module 760 is responsible for handling (generating/sending/receiving) signalling between the core network function and other nodes, such as the UE 3, the base station 5, and other core network nodes. The signalling may include for example a UE context/UE capability indication of a UE 3 related to energy saving.

As shown in FIG. 21, the core network node/function may also include an AI/ML module 770. If present, the AI/ML module 770 is operable to perform any of the AI/ML related functions of the core network node/function according to any of the methods described above. The core network node/function may be configured for training or re-training the AI/ML model as described above (for example, in response to UE mobility information that is fed back to the core network node/function from another node in the network, such as the base station 5).

### Modifications and Alternatives

As those skilled in the art will appreciate, a number of modifications and alternatives can be made to the above embodiments whilst still benefiting from the technical solutions or contributions embodied therein.

Whilst the above examples have been described with reference to an AI/ML model, it will be appreciated that the above described methods are advantageous even when the model is not an AI/ML model. Any other suitable type of model or function may be used to generate inferences (e.g. determinations or predictions). For example, the methods illustrated in FIG. 12 and FIG. 13 are useful for ensuring that mobility information is fed back to the node/function that generates mobility prediction information using the prediction model even when the model is not an AI/ML model (e.g. to verify the accuracy of model, even if the model cannot be trained or retrained). However, the methods are particularly advantageous when the model is an AI/ML model, since the information that is fed back to the primary network node/function can be used to iteratively update/train the model, or to trigger retraining.

It will be appreciated, for example, that whilst cellular communication generation (2G, 3G, 4G, 5G, 6G etc.) specific terminology may be used, in the interests of clarity, to refer to specific communication entities, the technical features described for a given entity are not limited to devices of that specific communication generation. The technical features may be implemented in any functionally equivalent communication entity regardless of any differences in the terminology used to refer to them.

In the above description, the UEs and the base station are described for ease of understanding as having a number of discrete functional components or modules. Whilst these modules may be provided in this way for certain applications, for example where an existing system has been modified to implement one or more of the technical solutions or contributions described above, in other applications, for example in systems designed with the inventive features in mind from the outset, these modules may be built into the overall operating system or code and so these modules may not be discernible as discrete entities.

In the above embodiments, a number of software modules were described. As those skilled in the art will appreciate, the software modules may be provided in compiled or un-compiled form and may be supplied as a signal over a computer network, or on a recording medium. Further, the functionality performed by part, or all of this software may be performed using one or more dedicated hardware circuits. However, the use of software modules is preferred as it facilitates the updating of the base station or the UE in order to update their functionalities.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like. Various other modifications will be apparent to those skilled in the art and will not be described in further detail here.

The base station may comprise a ‘distributed’ base station having a central unit ‘CU’ and one or more separate distributed units (DUs).

The User Equipment (or “UE”, “mobile station”, “mobile device” or “wireless device”) in the present disclosure is an entity connected to a network via a wireless interface.

It should be noted that the present disclosure is not limited to a dedicated communication device and can be applied to any device having a communication function as explained in the following paragraphs.

The terms “User Equipment” or “UE” (as the term is used by 3GPP), “mobile station”, “mobile device”, and “wireless device” are generally intended to be synonymous with one another, and include standalone mobile stations, such as terminals, cell phones, smart phones, tablets, cellular IoT devices, IoT devices, and machinery. It will be appreciated that the terms “mobile station” and “mobile device” also encompass devices that remain stationary for a long period of time.

A UE may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

A UE may, for example, be an item of transport equipment (for example transport equipment such as: rolling stocks; motor vehicles; motorcycles; bicycles; trains; buses; carts; rickshaws; ships and other watercraft; aircraft; rockets; satellites; drones; balloons etc.). A UE may, for example, be an item of information and communication equipment (for example information and communication equipment such as: electronic computer and related equipment; communication and related equipment; electronic components etc.).

A UE may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

A UE may, for example, be an electrical application system or equipment (for example an electrical application system or equipment such as: an x-ray system; a particle accelerator; radio isotope equipment; sonic equipment; electromagnetic application equipment; electronic power application equipment etc.).

A UE may, for example, be an electronic lamp, a luminaire, a measuring instrument, an analyser, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

A UE may, for example, be a wireless-equipped personal digital assistant or related equipment (such as a wireless card or module designed for attachment to or for insertion into another electronic device (for example a personal computer, electrical measuring machine)).

A UE may be a device or a part of a system that provides applications, services, and solutions described below, as to “internet of things (IoT)”, using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices. It will be appreciated that a UE may support one or more IoT or MTC applications. Some examples of MTC applications are listed in the following table. This list is not exhaustive and is intended to be indicative of some examples of machine-type communication applications.

TABLE 2

| Service Area | MTC applications |
|---|---|
| Security | Surveillance systems |
| | Backup for landline |
| | Control of physical access (e.g. to buildings) |
| | Car/driver security |
| Tracking & Tracing | Fleet Management |
| | Order Management |
| | Pay as you drive |
| | Asset Tracking |
| | Navigation |
| | Traffic information |
| | Road tolling |
| | Road traffic optimisation/steering |
| Payment | Point of sales |
| | Vending machines |
| | Gaming machines |
| Health | Monitoring vital signs |
| | Supporting the aged or handicapped |
| | Web Access Telemedicine points |
| | Remote diagnostics |
| Remote Maintenance/ | Sensors |
| Control | Lighting |
| | Pumps |
| | Valves |
| | Elevator control |
| | Vending machine control |
| | Vehicle diagnostics |
| Metering | Power |
| | Gas |
| | Water |
| | Heating |
| | Grid control |
| | Industrial metering |
| Consumer Devices | Digital photo frame |
| | Digital camera |
| | eBook |

Applications, services, and solutions may be an MVNO (Mobile Virtual Network Operator) service, an emergency radio communication system, a PBX (Private Branch exchange) system, a PHS/Digital Cordless Telecommunications system, a POS (Point of sale) system, an advertise calling system, an MBMS (Multimedia Broadcast and Multicast Service), a V2X (Vehicle to Everything) system, a train radio system, a location related service, a Disaster/Emergency Wireless Communication Service, a community service, a video streaming service, a femto cell application service, a VoLTE (Voice over LTE) service, a charging service, a radio on demand service, a roaming service, an activity monitoring service, a telecom carrier/communication NW selection service, a functional restriction service, a PoC (Proof of Concept) service, a personal information management service, an ad-hoc network/DTN (Delay Tolerant Networking) service, etc.

Further, the above-described UE categories are merely examples of applications of the technical ideas and example embodiments described in the present document. Needless to say, these technical ideas and example embodiments are not limited to the above-described UE and various modifications can be made thereto.

Various other modifications will be apparent to those skilled in the art and will not be described in further detail here.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. Each example embodiment can be appropriately combined with at least one of the other example embodiments.

The whole or part of the example embodiments disclosed above can be described as, but not limited to, the following supplementary notes. Some or all of the elements (e.g., configurations and functionality) described in the Supplementary Notes directed to a method (e.g., a method of a user equipment) may naturally also be described as or in Supplementary Notes directed to a device (e.g., a user equipment) or a program. For example, some or all of the elements listed in Supplementary Notes 2 through 20, which are dependent on Supplementary Note 1, may also be listed as Supplementary Notes dependent on Supplementary Note 65 with the same dependency as Supplementary Notes 2 through 20. Some or all of the elements described in any Supplementary Note may be applicable to various hardware, software, storage for storing software, systems, and methods.

### Supplementary Note 1

A method of a user equipment, UE, the method comprising:
receiving a broadcast or multicast transmission from an access network node, wherein the broadcast or multicast transmission includes an indication of an identity of one or more models for generating a determination, prediction or output parameter;
determining, based on the indication, to obtain a model of the one or more models;
transmitting a request for the model; and
receiving the model.

### Supplementary Note 2

The method according to Supplementary Note 1, wherein the model is an artificial intelligence or machine learning, AI/ML, model.

### Supplementary Note 3

The method according to Supplementary Note 1 or 2, wherein
transmitting the request for the model comprises transmitting the request to the access network node; and
receiving the model comprises receiving the model from the access network node.

### Supplementary Note 4

The method according to Supplementary Note 3, wherein receiving the model from the access network node comprises receiving the model in a radio resource control, RRC, message when the UE is in an RRC connected state.

### Supplementary Note 5

The method according to Supplementary Note 1 or 2, wherein:
transmitting the request for the model comprises transmitting the request to the access network node, a core network node, or a server that stores the model; and receiving the model comprises receiving the model from the server.

### Supplementary Note 6

The method according to Supplementary Note 5, wherein receiving the model from the server comprises receiving the model from the server via the access network node, via the core network node, or directly from the server.

### Supplementary Note 7

The method according to any preceding Supplementary Note, wherein the UE is in an RRC inactive state or an RRC idle state when the UE receives the broadcast or multicast transmission; and wherein the UE transmits the request as part of a random access procedure.

### Supplementary Note 8

The method according to Supplementary Note 7, wherein the random access procedure comprises:
transmitting a random access preamble to the access network node;
receiving a random access response from the access network node, the random access response including an indication of a communication resource for use by the UE for transmitting an uplink transmission; and
transmitting the uplink transmission to the access network node;
wherein the uplink transmission comprises the request for the model.

### Supplementary Note 9

The method according to Supplementary Note 8, wherein the uplink transmission includes a cause value that indicates that the uplink transmission includes the request for the model.

### Supplementary Note 10

The method according to any preceding Supplementary Note, wherein transmitting the request for the model comprises transmitting the request for the model in an RRC message; and
wherein the RRC message is a dedicated RRC message for requesting the model.

### Supplementary Note 11

The method according to any preceding Supplementary Note, wherein the method further comprises:
receiving, from the access network node, an indication of a time and/or frequency resource for use by the UE for receiving the model when the UE is in an RRC inactive or RRC idle state; and
receiving the model, from the access network node, using the indicated time and/or frequency resource when then UE is in the RRC inactive or RRC idle state.

### Supplementary Note 12

The method according to any preceding Supplementary Note, wherein the broadcast or multicast transmission includes an indication of a use case for at least one of the one or more models.

### Supplementary Note 13

The method according to any preceding Supplementary Note, wherein the broadcast or multicast transmission includes at least one of a model identification number or an indication of a model version of the one or more models.

### Supplementary Note 14

The method according to Supplementary Note 13, wherein the broadcast or multicast transmission includes the indication of the model version; and
the determination to obtain the model is based on a comparison of the indicated model version and a model version of a model stored at the UE.

### Supplementary Note 15

The method according to any preceding Supplementary Note, wherein receiving the model comprises receiving the model from a core network node using non-access stratum, NAS, signalling.

### Supplementary Note 16

The method according to any preceding Supplementary Note, wherein the indication of the identity of the one or more models is included in system information transmitted in the broadcast or multicast transmission.

### Supplementary Note 17

The method according to Supplementary Note 16, wherein the system information is on-demand system information, and wherein the method further comprises:
receiving, from the access network node, an indication that the on-demand system information is available for transmission by the access network node;
transmitting, to the access network node, a request for the on-demand system information; and
receiving the on-demand system information in the broadcast or multicast transmission.

### Supplementary Note 18

The method according to any preceding Supplementary Note, wherein the broadcast or multicast transmission is a group paging transmission.

### Supplementary Note 19

The method according to Supplementary Note 18, wherein the group paging transmission includes an indication that a version of the one or more models has been updated.

### Supplementary Note 20

The method according to Supplementary Note 19, wherein the group paging transmission includes a cause value that indicates that a model of the one or more models has been updated to a new version.

### Supplementary Note 21

A method of an access network node, the method comprising:
transmitting, to a user equipment, UE, a broadcast or multicast transmission, wherein the broadcast or multicast transmission includes an indication of an identity of one or more models for generating a determination, prediction or output parameter; and
receiving, from the UE, a request for a model of the one or more models.

### Supplementary Note 22

The method according to Supplementary Note 21, wherein the method further comprises transmitting the requested model to the UE.

### Supplementary Note 23

The method according to Supplementary Note 22, wherein a data radio bearer or logical channel for transmission of the requested model has an associated transmission priority or bit rate; and
wherein transmitting the requested model comprises transmitting the model using the data radio bearer or logical channel and based on the transmission priority or bit rate.

### Supplementary Note 24

The method according to Supplementary Notes 22 or 23, wherein the method comprises receiving the requested model from a central unit of a base station, a server, or a core network node, before transmitting the requested model to the UE.

### Supplementary Note 25

The method according to Supplementary Note 21, wherein the method further comprises transmitting, to the UE, an indication of a network node from which the UE is to obtain the requested model, or an indication network address for use by the UE to obtain the requested model.

### Supplementary Note 26

The method according to any one of Supplementary Notes 21 to 25, wherein the method comprises transmitting the broadcast or multicast transmission when the UE is in an RRC inactive state or an RRC idle state; and
wherein receiving the request comprises receiving the request as part of a random access procedure.

### Supplementary Note 27

The method according to Supplementary Note 26, wherein the random access procedure comprises:
receiving a random access preamble from the UE;
transmitting a random access response to the UE, the random access response including an indication of a communication resource for use by the UE for transmitting an uplink transmission; and
receiving the uplink transmission from the UE;
wherein the uplink transmission comprises the request for the model.

### Supplementary Note 28

The method according to any one of Supplementary Notes 21 to 27, wherein the method further comprises:
transmitting, to the UE, an indication of a time and/or frequency resource for use by the UE for receiving the model when the UE is in an RRC inactive or RRC idle state; and
transmitting the model, to the UE, using the indicated time and/or frequency resource when then UE is in the RRC inactive or RRC idle state.

### Supplementary Note 29

The method according to any one of Supplementary Notes 21 to 28, wherein the method comprises receiving, from a central unit of a base station, information indicating the identity of the one or more models, before transmitting the broadcast or multicast transmission that includes the indication of the identity of one or more models.

### Supplementary Note 30

The method according to any one of Supplementary Notes 21 to 29, wherein transmitting the broadcast or multicast transmission comprises transmitting the broadcast or multicast transmission periodically or based on a timer.

### Supplementary Note 31

The method according to any one of Supplementary Notes 21 to 30, wherein the broadcast or multicast transmission includes an indication of a use case for at least one of the one or more models.

### Supplementary Note 32

The method according to any one of Supplementary Notes 21 to 31, wherein the broadcast or multicast transmission includes at least one of a model identification number or an indication of a model version of the one or more models.

### Supplementary Note 33

The method according to any one of Supplementary Notes 21 to 32, wherein the indication of the identity of the one or more models is included in system information transmitted in the broadcast or multicast transmission.

### Supplementary Note 34

The method according to Supplementary Note 33, wherein the system information is on-demand system information, and wherein the method further comprises:

transmitting, to the UE, an indication that the on-demand system information is available for transmission by the access network node;

receiving, from the UE, a request for the on-demand system information; and

transmitting the on-demand system information in the broadcast or multicast transmission.

### Supplementary Note 35

The method according to any one of Supplementary Notes 21 to 34, wherein the broadcast or multicast transmission is a group paging transmission.

### Supplementary Note 36

The method according to Supplementary Note 35, wherein the group paging transmission includes an indication that a version of the one or more models has been updated.

### Supplementary Note 37

The method according to Supplementary Note 36, wherein the group paging transmission includes a cause value that indicates that a model of the one or more models has been updated to a new version.

### Supplementary Note 38

A method of a user equipment, UE, the method comprising:
receiving, from an access network node, an indication that a cell provided by the access network node is part of one or more areas that are each associated with a respective set of one or more models for generating a determination, prediction, or output;
determining, based on the received indication, to request a model of the one or more models;
transmitting a request for the model; and
receiving the model.

### Supplementary Note 39

The method according to Supplementary Note 38, wherein an area of the one or more areas comprises a group of cells, a radio access network based notification area, or a registration area.

### Supplementary Note 40

The method according to Supplementary Note 38 or 39, wherein the indication that the cell is part of the one or more areas is received in system information that is broadcast in the cell.

### Supplementary Note 41

The method according to any one of Supplementary Notes 38 to 40, wherein the method further comprises receiving, from the access network node, an indication of an identity of the one or more models.

### Supplementary Note 42

The method according to any one of Supplementary Notes 38 to 41, wherein the method further comprises receiving, from the access network node, an indication of one or more use cases of the one or more models.

### Supplementary Note 43

A method of a user equipment, UE, the method comprising:
receiving, from an access network node, an indication that a cell provided by the access network node is part of one or more areas that are each associated with a respective set of one or more models for generating a determination, prediction, or output parameter;
determining, based on the received indication, to obtain an indication of an identity of at least one of the models; and
obtaining the indication of the identity of at least one of the models.

### Supplementary Note 44

The method according to Supplementary Note 43, wherein obtaining the indication of the identity at least one of the models comprises receiving system information that is broadcast in the cell by the access network node.

### Supplementary Note 45

The method according to Supplementary Note 44, wherein the method further comprises determining to receive the system information periodically or based on a timer.

### Supplementary Note 46

The method according to any one of Supplementary Notes 43 to 45, wherein the method further comprises determining, based on the indication of the identity of at least one of the models, to obtain a model of the one or more models;
transmitting a request for the model; and
receiving the model.

### Supplementary Note 47

The method according to any one of Supplementary Notes 43 to 46, wherein the method further comprises, after obtaining the indication of the identity of at least one of the models:
selecting a model, of the one or more models for use in the cell, that is stored at the UE; and
using the model to generate a determination, prediction, or output parameter.

### Supplementary Note 48

The method according to Supplementary Note 47, wherein the method further comprises transmitting, to the access network node, an indication of the selected model.

### Supplementary Note 49

The method according to Supplementary Note 48, wherein transmitting the indication of the selected model comprises transmitting the indication of the selected model using in a radio resource control, RRC, message.

### Supplementary Note 50

A method of an access network node, the method comprising:
transmitting an indication that a cell provided by the access network node is part of one or more areas that are each associated with a respective set of one or more models for generating a determination, prediction, or output; and
receiving, from a UE that has received the indication, a request for a model of the one or more models.

### Supplementary Note 51

A method of an access network node, the method comprising:
transmitting an indication that a cell provided by the access network node is part of one or more areas that are each associated with a respective set of one or more models for generating a determination, prediction, or output;
receiving, from a UE that has received the indication, a request for an identity of a model of the one or more models; and transmitting an indication of the identity of one or more models.

### Supplementary Note 52

The method according to Supplementary Note 51, wherein transmitting the indication of the identity of one or more models for use in the cell comprises transmitting the indication of the identity of one or more models for use in the cell in system information that is broadcast in the cell.

### Supplementary Note 53

The method according to Supplementary Note 52, wherein the method further comprises transmitting the system information periodically or based on a timer.

### Supplementary Note 54

A method of a user equipment, UE, the method comprising:
transitioning from a radio resource control, RRC, idle or RRC inactive state to an RRC connected state; and
transmitting to an access network node, an indication of at least one of:
an identity of one or more models stored at the UE,
a status of the one or more models stored at the UE, or
a version number of the one or more models stored at the UE;
wherein the one or more models are for generating a determination, prediction or output parameter.

### Supplementary Note 55

The method according to Supplementary Note 54, wherein the indication is transmitted to the access network node using layer 1, L1, signalling, layer 2, L2, signalling, or layer 3, L3, signalling.

### Supplementary Note 56

The method according to Supplementary Note 54 or 55, wherein transmitting the indication of the identity of the one or models comprises transmitting the indication of the identity of the one or models in an RRC message after the UE has entered the RRC connected state.

### Supplementary Note 57

A method of an access network node, the method comprising:
receiving, from a user equipment, UE, an indication of at least one of:
an identity of one or more models stored at the UE,
a status of the one or more models stored at the UE, or
a version number of the one or more models stored at the UE; and
determining, based on the received indication, a model of the one or more models to use at the access network node;
wherein the one or more models are for generating a determination, prediction or output parameter.

### Supplementary Note 58

The method according to Supplementary Note 57, wherein the method further comprises transmitting, to the UE, an indication of the determined model.

### Supplementary Note 59

A method of a user equipment, UE, the method comprising:
storing a model for generating a determination, prediction or output parameter;
transitioning from a radio resource control, RRC, connected state to an RRC idle or RRC inactive state; and
continuing to store the model after the transition from the RRC connected state to the RRC idle or RRC inactive state.

### Supplementary Note 60

The method according to Supplementary Note 59, wherein the method comprises storing the model for a predetermined time duration after the UE has entered the RRC idle or RRC inactive state.

### Supplementary Note 61

A method of an access network node, the method comprising,
transmitting, to a user equipment, UE, in a first radio resource control, RRC message, a request for an indication of an identity of a model stored at the UE, wherein the model is for generating a determination, prediction or output parameter; and
receiving, from the UE, in a second RRC message, the indication of the identity of the model stored at the UE.

### Supplementary Note 62

A method of a user equipment, UE, the method comprising,
receiving, from an access network node, in a first radio resource control, RRC message, a request for an indication of an identity of a model stored at the UE, wherein the model is for generating a determination, prediction or output parameter; and
transmitting, in a second RRC message, to the access network node, the indication of the identity of the model stored at the UE.

### Supplementary Note 63

A method of a user equipment, UE, the method comprising,
transmitting, to an access network node, in a first radio resource control, RRC message, a request for an indication of a model supported for a use case, wherein the model is for generating a determination, prediction or output parameter for the use case; and
receiving, from the access network node, in a second RRC message, an indication of the identity of the model.

### Supplementary Note 64

A method of an access network node, the method comprising,
receiving, from a user equipment, UE, in a first radio resource control, RRC message, a request for an indication of a model supported for a use case, wherein the model is for generating a determination, prediction or output parameter for the use case; and
transmitting, to the UE, in a second RRC message, an indication of the identity of the model.

### Supplementary Note 65

A user equipment, UE, comprising:
means for receiving a broadcast or multicast transmission from an access network node, wherein the broadcast or multicast transmission includes an indication of an identity of one or more models for generating a determination, prediction or output parameter;
means for determining, based on the indication, to obtain a model of the one or more models; and
means for transmitting a request for the model;
wherein the means for receiving is configured for receiving the model.

### Supplementary Note 66

An access network node comprising:
means for transmitting, to a user equipment, UE, a broadcast or multicast transmission, wherein the broadcast or multicast transmission includes an indication of an identity of one or more models for generating a determination, prediction or output parameter; and
means for receiving, from the UE, a request for a model of the one or more models.

### Supplementary Note 67

A user equipment, UE, comprising:
means for receiving, from an access network node, an indication that a cell provided by the access network node is part of one or more areas that are each associated with a respective set of one or more models for generating a determination, prediction, or output;
means for determining, based on the received indication, to request a model of the one or more models; and
means for transmitting a request for the model;
wherein the means for receiving is configured for receiving the model.

### Supplementary Note 68

A user equipment, UE, comprising:
means for receiving, from an access network node, an indication that a cell provided by the access network node is part of one or more areas that are each associated with a respective set of one or more models for generating a determination, prediction, or output parameter;
means for determining, based on the received indication, to obtain an indication of an identity of at least one of the models; and
means for obtaining the indication of the identity of at least one of the models.

### Supplementary Note 69

An access network node comprising:
means for transmitting an indication that a cell provided by the access network node is part of one or more areas that are each associated with a respective set of one or more models for generating a determination, prediction, or output; and
means for receiving, from a UE that has received the indication, a request for a model of the one or more models.

### Supplementary Note 70

An access network node comprising:
means for transmitting an indication that a cell provided by the access network node is part of one or more areas that are each associated with a respective set of one or more models for generating a determination, prediction, or output; and
means for receiving, from a UE that has received the indication, a request for an identity of a model of the one or more models;
wherein the means for transmitting is configured for transmitting an indication of the identity of one or more models.

### Supplementary Note 71

A user equipment, UE, comprising:
means for transitioning from a radio resource control, RRC, idle or RRC inactive state to an RRC connected state; and
means for transmitting to an access network node, an indication of at least one of:
an identity of one or more models stored at the UE,
a status of the one or more models stored at the UE, or
a version number of the one or more models stored at the UE;
wherein the one or more models are for generating a determination, prediction or output parameter.

### Supplementary Note 72

An access network node comprising:
means for receiving, from a user equipment, UE, an indication of at least one of:
an identity of one or more models stored at the UE,
a status of the one or more models stored at the UE, or
a version number of the one or more models stored at the UE; and
means for determining, based on the received indication, a model of the one or more models to use at the access network node;
wherein the one or more models are for generating a determination, prediction or output parameter.

### Supplementary Note 73

A user equipment, UE, comprising:
means for storing a model for generating a determination, prediction or output parameter; and
means for transitioning from a radio resource control, RRC, connected state to an RRC idle or RRC inactive state;
wherein the UE is configured to continue to store the model after the transition from the RRC connected state to the RRC idle or RRC inactive state.

### Supplementary Note 74

An access network node comprising,
means for transmitting, to a user equipment, UE, in a first radio resource control, RRC message, a request for an indication of an identity of a model stored at the UE, wherein the model is for generating a determination, prediction or output parameter; and
means for receiving, from the UE, in a second RRC message, the indication of the identity of the model stored at the UE.

### Supplementary Note 75

A user equipment, UE, comprising,
means for receiving, from an access network node, in a first radio resource control, RRC message, a request for an indication of an identity of a model stored at the UE, wherein the model is for generating a determination, prediction or output parameter; and
means for transmitting, in a second RRC message, to the access network node, the indication of the identity of the model stored at the UE.

### Supplementary Note 76

A user equipment, UE, comprising,
means for transmitting, to an access network node, in a first radio resource control, RRC message, a request for an indication of a model supported for a use case, wherein the model is for generating a determination, prediction or output parameter for the use case; and
means for receiving, from the access network node, in a second RRC message, an indication of the identity of the model.

### Supplementary Note 77

An access network node comprising,
means for receiving, from a user equipment, UE, in a first radio resource control, RRC message, a request for an indication of a model supported for a use case, wherein the model is for generating a determination, prediction or output parameter for the use case; and
means for transmitting, to the UE, in a second RRC message, an indication of the identity of the model.

### Supplementary Note A1

A method of a user equipment, UE, the method comprising:
receiving, from an access network node, at least one identity of a respective artificial intelligence or machine learning, AI/ML, model;
transmitting, to the access network node, a request for a first AI/ML model, the request including an identity of the first AI/ML model, wherein the identity of the first AI/ML model is included in the at least one identity of the respective AI/ML model; and
receiving, from the access network node, the first AI/ML model.

### Supplementary Note A2

The method according to Supplementary Note A1, further comprising:
determining whether the UE needs to transmit the request for the first AI/ML model based on comparing the at least one identity of the respective AI/ML model with at least one AI/ML model which the UE stores, and
wherein the transmitting the request is performed if the UE determines that the UE needs to transmit the request.

### Supplementary Note A3

The method according to Supplementary Note A1 or A2, wherein
the transmitting the request is performed by transmitting a message of a random access procedure or a Radio Resource Control, RRC, message including the request.

### Supplementary Note A4

The method according to Supplementary Note A3, wherein
a cause value indicating an intension of receiving the first AI/ML model is transmitted along with the request.

### Supplementary Note A5

The method according to any one of Supplementary Notes A1 to A4, wherein
the transmitting the request is performed after being connected with the access network node.

### Supplementary Note A6

The method according to any one of Supplementary Notes A1 to A5, wherein the receiving the AI/ML model is included in at least one of:
a broadcast message in a case where the UE is in a RRC Idle state or a RRC Inactive state,
a multicast message in a case where the UE is in a RRC Inactive state or a RRC Connected state,
a dedicated RRC message in a case where the UE is in a RRC Connected state,
a user plane data transmitted via a data radio bearer, or
a data transmitted via a radio bearer specific to transmission of AI/ML models.

### Supplementary Note A7

The method according to Supplementary Note A6, wherein
the receiving the AI/ML model is included in the broadcast message or the multicast message, and the method comprises:
receiving information for a resource for receiving the AI/ML model included in the broadcast message or the multicast message, and wherein
the receiving the AI/ML model is performed using the resource.

### Supplementary Note A8

The method according to Supplementary Note A6, wherein
the receiving the AI/ML model is included in the user plane data transmitted via the data radio bearer, and
a specific priority is assigned to the data radio bearer or a logical channel carrying the first AI/ML model.

### Supplementary Note A9

The method according to Supplementary Note A6, wherein
the receiving the AI/ML model is included in the data transmitted via the radio bearer specific to transmission of AI/ML models, and
a logical channel carrying the first AI/ML model is subject to restriction on multiplexing with other logical channels carrying signal radio bearers and/or data radio bearers.

### Supplementary Note A10

The method according to any one of Supplementary Notes A1 to A9, wherein
the first AI/ML model stores another entity, and
the request is forwarded via the access network node, and
the receiving the first AI/ML model is received from the another entity via the access network node.

### Supplementary Note A11

The method according to Supplementary Note A10, wherein
the another entity includes an over-the-top server which is coupled to a core network node for mobility management, and
the receiving the first AI/ML model is received from the over-the-top server via the core network node for mobility management using a non-access stratum, NAS, message.

### Supplementary Note A12

The method according to any one of Supplementary Notes A1 to A11, wherein
the access network node comprises a central unit and a distributed unit,
the at least one identity of the respective artificial intelligence or machine learning, AI/ML, model is transmitted from the central unit via the distributed unit, and
the first AI/ML model is transmitted from the central unit via the distributed unit.

### Supplementary Note A13

The method according to any one of Supplementary Notes A1 to A12, wherein
the receiving the at least one identity of the respective AI/ML model is included in at least one of:
   a broadcast message in a case where the UE is in a RRC Idle state or a RRC Inactive state,
   a multicast message in a case where the UE is in a RRC Inactive state or a RRC Connected state, or
   a dedicated RRC message in a case where the UE is in a RRC Connected state.

### Supplementary Note A14

The method according to Supplementary Note A13, wherein
the receiving the at least one identity of the respective AI/ML model is included in the broadcast message, and
the method comprises:
   receiving a system information block indicating availability of the at least one identity of the respective AI/ML model; and
   determining whether to receive the at least one identity of the respective AI/ML model.

### Supplementary Note A15

The method according to Supplementary Note A14, wherein the broadcast message is transmitted periodically or on-demand.

### Supplementary Note A16

The method according to Supplementary Note A14 or A15, wherein
the broadcast message includes the at least one identity of the respective AI/ML model, and information indicating a respective version of the at least one identity of the respective AI/ML model, and
the determining is performed based on the information indicating a version of the first AI/ML model.

### Supplementary Note A17

The method according to Supplementary Note A16, further comprising: determining whether to transmit the request based on the version of the first AI/ML model and a timer value stored in the UE.

### Supplementary Note A18

The method according to Supplementary Note A16 or A17, further comprising:
receiving a first message; and
performing, based on the first message, at least one of:
   requesting the access network node to provide at least one updated AI/ML model, or
   transmitting information indicating a respective version of at least one AI/ML model which the UE stores.

### Supplementary Note A19

The method according to Supplementary Note A18, wherein
the first message includes at least one of:
   at least one identity of at least one AI/ML model, or
   a respective version of the at least one AI/ML model, and
the performing is performed based on the at least one of:
   the at least one identity of at least one AI/ML model, or
   the respective version of the at least one AI/ML model.

### Supplementary Note A20

The method according to Supplementary Note A18 or A19, wherein
the first message includes information indicating a group of UEs.

### Supplementary Note A21

The method according to any one of Supplementary Notes A18 to A20, wherein
the first message includes a cause value indicating that update of at least one AI/ML model is needed.

### Supplementary Note A22

The method according to any one of Supplementary Notes A18 to A21, wherein
the first message includes at least one of:
   a RRC message, or
   a paging message.

### Supplementary Note A23

The method according to any one of Supplementary Notes A1 to A22, wherein
at least one model area corresponding to the respective AI/ML model is transmitted along with the at least one identity of the respective AI/ML model.

### Supplementary Note A24

The method according to Supplementary Note A23, wherein
each of the at least one model area is represented by at least one of:
   at least one of cell,
   a Radio Access Network, RAN, notification area, RNA, or
   a registration area.

### Supplementary Note A25

The method according to Supplementary Note A23 or A24, wherein
a cell operated by the access network node is covered by at least one model area.

### Supplementary Note A26

The method according to any one of Supplementary Notes A1 to A25, wherein
a respective model area in which the respective AI/ML model is applicable is transmitted along with the at least one identity of the respective AI/ML model.

### Supplementary Note A27

The method according to Supplementary Note A26, wherein
the respective model area is represented by at least one of:
   a list of at least one cell,
   a Radio Access Network, RAN, based Notification Area, RNA, or
   at least one registration area.

### Supplementary Note A28

The method according to Supplementary Note A26 or A27, wherein
the respective model area is specific to an operator or a vendor.

### Supplementary Note A29

The method according to any one of Supplementary Notes A23 to A28, further comprising:
in a case where the UE is in a RRC Idle state or in a RRC Inactive state, detecting that a model area corresponding to an AI/ML model has been updated;
in a case where the UE intends to use the AI/ML model, requesting the access network node to transmit an AI/ML model corresponding to the update of the model area.

### Supplementary Note A30

The method according to any one of Supplementary Notes A23 to A28, further comprising:
in a case where the UE is in a RRC Idle state or in a RRC Inactive state, requesting the access network node to update a model area during a cell selection procedure or a cell reselection procedure.

### Supplementary Note A31

The method according to any one of Supplementary Notes A23 to A28, further comprising:
switching an AI/ML model to use based on update of a model area after a cell selection procedure or a cell reselection procedure.

### Supplementary Note A32

The method according to any one of Supplementary Notes A1 to A31, wherein
each of the respective AI/ML model corresponds to a respective feature of usage of the respective AI/ML model.

### Supplementary Note A33

The method according to Supplementary Note A32, wherein
the at least one identity of the respective AI/ML model is transmitted per feature of the usage, or per AI/ML model.

### Supplementary Note A34

The method according to Supplementary Note A32 or A33, wherein
one AI/ML model of a specific feature of usage of the AI/ML model corresponds to a model area.

### Supplementary Note A35

The method according to Supplementary Note A34, wherein
each of a plurality of AI/ML models of the specific feature of usage of the AI/ML model corresponds to a respective model area, and the method comprises:
transmitting, to the access network node, information indicating a preference for the UE to use a specific AI/ML model from the plurality of AI/ML models for the specific feature of the usage of the AI/ML model.

### Supplementary Note A36

The method according to Supplementary Note A35, wherein
the information indicating the preference is transmitted in an initial RRC message when connecting to the access network node.

### Supplementary Note A37

The method according to any one of Supplementary Notes A1 to A36, further comprising:
in a case where the UE transits from a RRC Idle state to a RRC connected state, transmitting, to the access network node, information indicating at least one identity of a respective AI/ML model.

### Supplementary Note A38

The method according to Supplementary Note A37, wherein
the information indicating the at least one identity of the respective AI/ML model includes:
   information indicating a version of the respective AI/ML model, and
   a status of the respective AI/ML model for all of features supported by the UE.

### Supplementary Note A39

The method according to any one of Supplementary Notes A1 to A38, further comprising:
in a case where the UE transits from a RRC Connected state to a RRC Idle state or a RRC inactive state, holding at least one AI/ML model the UE stores for a given time period.

### Supplementary Note A40

The method according to any one of Supplementary Notes A1 to A39, further comprising:
transmitting, the access network node, a RRC message for requesting the at least one identity of the respective AI/ML model, and wherein
the receiving the at least one identity of the respective AI/ML model is performed in response to the requesting.

### Supplementary Note A41

A method of an access network node, the method comprising:
transmitting, to a user equipment, UE, at least one identity of a respective artificial intelligence or machine learning, AI/ML, model;
receiving, from the UE, a request for a first AI/ML model, the request including an identity of the first AI/ML model, wherein the identity of the first AI/ML model is included in the at least one identity of the respective AI/ML model; and
transmitting, to the UE, the first AI/ML model.

### Supplementary Note A42

A user equipment, UE, comprising:
means for receiving, from an access network node, at least one identity of a respective artificial intelligence or machine learning, AI/ML, model;
means for transmitting, to the access network node, a request for a first AI/ML model, the request including an identity of the first AI/ML model, wherein the identity of the first AI/ML model is included in the at least one identity of the respective AI/ML model; and
means for receiving, from the access network node, the first AI/ML model.

### Supplementary Note A43

An access network node, comprising:
means for transmitting, to a user equipment, UE, at least one identity of a respective artificial intelligence or machine learning, AI/ML, model;
means for receiving, from the UE, a request for a first AI/ML model, the request including an identity of the first AI/ML model, wherein the identity of the first AI/ML model is included in the at least one identity of the respective AI/ML model; and
means for transmitting, to the UE, the first AI/ML model.

This application is based upon and claims the benefit of priority from Great Britain Patent Application No. 2302234.6, filed on Feb. 16, 2023, the disclosure of which is incorporated herein in its entirety by reference.

What is claimed is:

1.-43. (canceled)

44. A method of a mobile device, the method comprising:
receiving, from an access network node, information indicating at least one artificial intelligence/machine learning (AI/ML) model;
transmitting, to the access network node, a request for a first AI/ML model, the request including information indicating the first AI/ML model, wherein the first AI/ML model is included in the at least one AI/ML model; and
receiving, from the access network node, the first AI/ML model.

45. The method according to claim 44, further comprising:
determining whether the mobile device needs to transmit the request for the first AI/ML model based on comparing the information indicating the at least one AI/ML model with at least one AI/ML model which the mobile device stores, and
wherein the transmitting the request is performed if the mobile device determines that the mobile device needs to transmit the request.

46. The method according to claim 44, wherein
the transmitting the request is performed by transmitting a message of a random access procedure or a Radio Resource Control (RRC) message including the request.

47. The method according to claim 44, wherein
the receiving the first AI/ML model is included in at least one of:
a broadcast message in a case where the mobile device is in a RRC Idle state or a RRC Inactive state,
a multicast message in a case where the mobile device is in a RRC Inactive state or a RRC Connected state,
a dedicated RRC message in a case where the mobile device is in a RRC Connected state,
a user plane data transmitted via a data radio bearer, or
a data transmitted via a radio bearer specific to transmission of AI/ML models.

48. The method according to claim 47, wherein
the receiving the first AI/ML model is included in the broadcast message or the multicast message, and the method comprises:
receiving information for a resource for receiving the first AI/ML model included in the broadcast message or the multicast message, and wherein
the receiving the first AI/ML model is performed using the resource.

49. The method according to claim 47, wherein
the receiving the first AI/ML model is included in the user plane data transmitted via the data radio bearer, and
a specific priority is assigned to the data radio bearer or a logical channel carrying the first AI/ML model.

50. The method according to claim 47, wherein
the receiving the first AI/ML model is included in the data transmitted via the radio bearer specific to transmission of AI/ML models, and
a logical channel carrying the first AI/ML model is subject to restriction on multiplexing with other logical channels carrying signal radio bearers and/or data radio bearers.

51. The method according to claim 44, wherein
the first AI/ML model is stored in another entity, and
the request is forwarded via the access network node, and
the receiving the first AI/ML model is received from the another entity via the access network node.

52. The method according to claim 44, wherein
the access network node comprises a central unit and a distributed unit,
the information indicating the at least one AI/ML model is transmitted from the central unit via the distributed unit, and
the first AI/ML model is transmitted from the central unit via the distributed unit.

53. The method according to claim 44, wherein
the receiving the information indicating the at least one AI/ML model is included in at least one of:
a broadcast message in a case where the mobile device is in a RRC Idle state or a RRC Inactive state,
a multicast message in a case where the mobile device is in a RRC Inactive state or a RRC Connected state, or
a dedicated RRC message in a case where the mobile device is in a RRC Connected state.

54. The method according to claim 44, wherein
at least one model area corresponding to the at least one AI/ML model is transmitted along with the information indicating the at least one AI/ML model.

55. The method according to claim 44, wherein
a respective model area in which the at least one AI/ML model is applicable is transmitted along with the information indicating the at least one AI/ML model.

56. The method according to claim 44, wherein
each of the at least one AI/ML model corresponds to a respective feature of usage of the at least one AI/ML model.

57. The method according to claim 44, further comprising:
in a case where the mobile device transits from a RRC Idle state to a RRC connected state, transmitting, to the access network node, second information indicating at least one AI/ML model.

58. The method according to claim 57, wherein
the second information indicating the at least one AI/ML model includes:
information indicating a version of the at least one AI/ML model, and
a status of the at least one AI/ML model for all of features supported by the mobile device.

59. The method according to claim 44, further comprising:
in a case where the mobile device transits from a RRC Connected state to a RRC Idle state or a RRC inactive state, holding at least one AI/ML model stored in the mobile device for a given time period.

60. The method according to claim 44, further comprising:
transmitting, the access network node, a RRC message for requesting the information indicating the at least one AI/ML model, and wherein
the receiving the information indicating the at least one AI/ML model is performed in response to the requesting.

61. A method of an access network node, the method comprising:
transmitting, to a mobile device, information indicating at least one artificial intelligence/machine learning (AI/ML) model;
receiving, from the mobile device, a request for a first AI/ML model, the request including information indicating the first AI/ML model, wherein the first AI/ML model is included in the at least one AI/ML model; and
transmitting, to the UE, the first AI/ML model.

62. A mobile device, comprising:
at least one memory storing instructions; and
at least one processor configured to process the instructions to cause the mobile device to:
receive, from an access network node, information indicating at least one artificial intelligence/machine learning (AI/ML) model;
transmit, to the access network node, a request for a first AI/ML model, the request including information indicating the first AI/ML model, wherein the first AI/ML model is included in the at least one AI/ML model; and
receive, from the access network node, the first AI/ML model.

63. An access network node, comprising:
at least one memory storing instructions; and
at least one processor configured to process the instructions to the access network node to:
transmit, to a mobile device, information indicating at least one artificial intelligence/machine learning (AI/ML) model;
receive, from the mobile device, a request for a first AI/ML model, the request including information indicating the first AI/ML model, wherein the first AI/ML model is included in the at least one AI/ML model; and
transmit, to the mobile device, the first AI/ML model.
